(19) United States
(12) Patent Application Publication
(10) Pub. No.: US 2025/0186889 A1
(43) Pub. Date: Jun. 12, 2025

(54) INFORMATION PROCESSING SYSTEM, STORAGE MEDIUM, AND INFORMATION PROCESSING METHOD

(71) Applicant: NINTENDO CO., LTD., Kyoto (JP)

(72) Inventors: Tsubasa SAKAGUCHI, Kyoto (JP); Yusuke AMANO, Kyoto (JP); Masaki WADA, Kyoto (JP); Shinya YANO, Kyoto (JP)

(21) Appl. No.: 18/966,807

(22) Filed: Dec. 3, 2024

(30) Foreign Application Priority Data
Dec. 12, 2023 (JP) 2023-209179

(51) Int. Cl. A63F 13/56; A63F 13/52; G06T 13/40; G06T 19/20

(52) U.S. Cl. CPC A63F 13/56; A63F 13/52; G06T 13/40; G06T 19/20; G06T 2219/2004; G06T 2219/2016

(57) ABSTRACT

A virtual space including a plurality of sections is generated. A virtual space image showing the virtual space is generated. A player character operated by the user in the virtual space is moved according to a first input performed by the user. The player character is caused to perform a first action on an object or another player character associated with another user in the virtual space according to a second input performed by the user. Activity amount information based on at least the number of times the first action has been performed during a period of time is stored into the storage unit for each section. A section information image showing the activity amount information for each of a portion of the plurality of sections is generated based on the stored activity amount information according to a third input performed by the user.

### CROSS REFERENCE TO RELATED APPLICATION

This application claims priority to Japanese Patent Application No. 2023-209179, filed on Dec. 12, 2023, the entire contents of which are incorporated herein by reference.

### FIELD

The technology disclosed herein relates to information processing systems, storage media, information processing methods, and the like.

### BACKGROUND AND SUMMARY

There have conventionally been some information processing systems in which a map image additionally showing the current locations of other player characters is displayed.

However, in such information processing systems, a place where a social activity frequently occurs between player characters cannot be found only by viewing the map image.

With the above in mind, it is an object of the present example to provide an information processing system, storage medium, and information processing method in which an activity amount related to a player character's action in each section can be checked.

To achieve the object, the present example may have features (1) to (13) below, for example.
(1) An example configuration of an information processing system according to the present example is an information processing system comprising: one or more processors; a server including a storage unit; a plurality of information processing apparatuses configured to connect to the server; and one or more memories storing a program that, when executed, causes the information processing system to perform, based on users' inputs performed on the plurality of information processing apparatuses, operations including: generating a virtual space including a plurality of sections based on data received from the server; generating a virtual space image showing the virtual space; moving a player character operated by the user in the virtual space according to a first input performed by the user; causing the player character to perform a first action on an object associated with another user in the virtual space according to a second input performed by the user; storing, into the storage unit, activity amount information based on at least the number of times the first action has been performed during a period of time for each section; and generating a section information image showing the activity amount information for each of a portion of the plurality of sections based on the activity amount information stored in the storage unit according to a third input performed by the user.

With the configuration of (1), an activity amount for each section based on an action performed by a player character on an object associated with another user can be checked.
(2) In the configuration of (1), the section may include a plurality of unit regions associated with one of a first and a second state. Further, the player character may be caused to perform a second action of choosing at least one of the unit regions based on a fourth input performed by the user, the second action being different from the first action. The server may change a state of the unit region chosen by the second action to the second state, and store, into the storage unit, unit region information based on the number of unit regions in the second state for each section. The server may generate the section information image further showing the unit region information for each section.

With the configuration of (2), the unit region information based on a state of a section can be checked for each section.
(3) In the configuration of (1) or (2), the activity amount information shown in the section information image may be represented, for each section, by an animation that extends and contracts in a height direction of the section.

With the configuration of (3), the activity amount can be presented for each section in an easy-to-understand manner.
(4) In the configuration of (2), further, the section information image may be generated by arranging the plurality of sections in a horizontal direction. For each section in the section information image, a number-of-unit-regions object that is more enlarged in the horizontal direction as the number of the unit regions in the second state indicated by the unit region information increases in the section, and an activity amount object that is more elongated in a vertical direction as the number of times the first action has been performed that is indicated by the activity amount information increases in the section, may be arranged.

With the configuration of (4), both the activity amount and the unit region information can be presented for each section in an easy-to-understand manner.
(5) In the configuration of (2), further, the section information image may be generated by arranging the plurality of sections in a horizontal direction. For each section in the section information image, a number-of-unit-regions object that is more enlarged in the horizontal direction as the number of the unit regions in the second state indicated by the unit region information increases in the section, and an activity amount object whose movement speed increases as the number of times the first action has been performed that is indicated by the activity amount information increases in the section, may be arranged.

With the configuration of (5), both the activity amount and the unit region information can be presented for each section in an easy-to-understand manner.
(6) In the configuration of (2), further, the section information image may be generated by arranging the plurality of sections in a horizontal direction. For each section in the section information image, a number-of-unit-regions object that is more enlarged in the horizontal direction as the number of the unit regions in the second state indicated by the unit region information increases in the section, and an activity amount object whose rotational speed increases as the number of times the first action has been performed that is indicated by the activity amount information increases in the section, may be arranged.

With the configuration of (6), both the activity amount and the unit region information can be presented for each section in an easy-to-understand manner.
(7) In the configuration of any one of (1) to (6), the activity amount information may further include information based on distances over which the player character and another player character operated by another user have moved during a period of time for each section.

With the configuration of (7), the activity amount based on the amount of movement of each player character in each section can be checked.
(8) In the configuration of any one of (1) to (7), the activity amount information may further include information based on at least one of a distance and a time over which the player character has moved on an object arranged in the virtual space by another user during a period of time for each section, and information based on at least one of a distance and a time over which another player character operated by the another user has moved on an object arranged in the virtual space by the user during the period of time for each section.

With the configuration of (8), the activity amount based on at least one of a situation in which a player character has used an object arranged in the virtual space by another user and a situation in which the another character has used an object arranged in the virtual space by the user can be checked.
(9) In the configuration of any one of (1) to (8), the server may store, into the storage unit, the number of the player characters located in each section. The activity amount information may further include information based on the number of the player characters located in each section at a time or during a period of time.

With the configuration of (9), the activity amount based on the number of player characters in each section can be checked.
(10) In the configuration of any one of (1) to (9), the first action may be the player character's action that is performed on an object that has been generated or edited in the virtual space based on the another user's operation to be associated with the another user.

With the configuration of (10), the activity amount based on a player character's action that is performed on an object that has been generated or edited in the virtual space based on another user's operation can be checked.
(11) In the configuration of any one of (1) to (10), the first action may be the player character's action that is performed on an object that exists in the virtual space and has been duplicated based on the another user's operation to be associated with the another user.

With the configuration of (11), the activity amount based on a player character's action that is performed on an object that has been duplicated in the virtual space based on another user's operation can be checked.
(12) In the configuration of any one of (1) to (11), the first action may be performed on one of a plurality of objects relating to the another user. The number of the first actions may be counted, considering that the first action has been performed in the section including a location where the player character that has performed the first action is located, or a location where an object on which the first action has been performed is located.

With the configuration of (12), the activity amount based on a location where an action has been performed can be checked.
(13) Another example configuration of an information processing system according to the preset example is an information processing system comprising: one or more processors; a server including a storage unit; a plurality of information processing apparatuses configured to connect to the server; and one or more memories storing a program that, when executed, causes the information processing system to perform, based on users' inputs performed on the plurality of information processing apparatuses, operations including: generating a virtual space including a plurality of sections based on data received from the server; generating a virtual space image showing the virtual space; moving a player character operated by the user in the virtual space according to a first input performed by the user; causing the player character to perform a first action on another player character operated by another user in the virtual space according to a second input performed by the user; storing, into the storage unit, activity amount information based on at least the number of times the first action has been performed during a period of time for each section; and generating a section information image showing the activity amount information for each of a portion of the plurality of sections based on the activity amount information stored in the storage unit according to a third input performed by the user.

With the configuration of (13), an activity amount associated with actions between player characters in each section can be checked.

In addition, the present example may be carried out in the forms of a storage medium and information processing method.

According to the present example, an activity amount associated with actions between player characters in each section can be checked.

These and other objects, features, aspects and advantages of the present exemplary embodiment will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a block diagram illustrating a non-limiting example configuration of an information processing system,

FIG. 9 is a block diagram illustrating a non-limiting example configuration of a server 102,

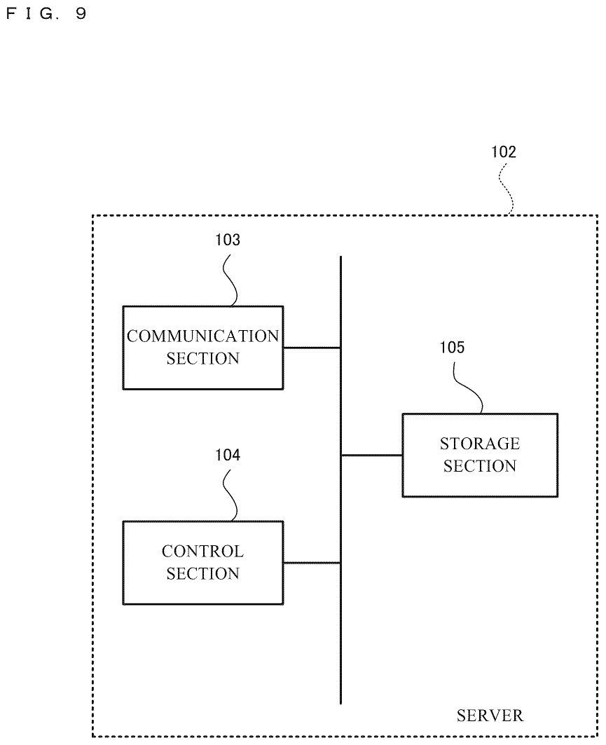

FIG. 10 is a diagram illustrating a non-limiting example of a game image showing a plurality of player characters PC arranged in the same game space,

FIG. 11 is a diagram illustrating a non-limiting example in which a creator and an editor of a terrain object Lx are displayed,

FIG. 12 is a diagram illustrating a non-limiting example in which a terrain object OBJ1 obtained by moving and joining a plurality of terrain objects is generated in a game space,

FIG. 13 is a diagram illustrating a non-limiting example in which a high rating is given to a terrain object OBJ1 generated by a first player character PC1,

FIG. 14 is a diagram illustrating a non-limiting example of a terrain object OBJ1 edited by a second player character PC2,

FIG. 15 is a diagram illustrating a non-limiting example in which a high rating is given to a terrain object OBJ1 edited by a second player character PC2,

FIG. 16 is a diagram illustrating a non-limiting example of a terrain object OBJ1 edited by a third player character PC3,

FIG. 17 is a diagram illustrating a non-limiting example in which a high rating is given to a terrain object OBJ1 edited by a third player character PC3,

FIG. 18 is a diagram illustrating a non-limiting example of a decorative object D1 generated by a first player character PC1,

FIG. 19 is a diagram illustrating a non-limiting example in which a high rating is given to a decorative object D1 generated by a first player character PC1,

FIG. 20 is a diagram illustrating a non-limiting example of a decorative object D1c that is a duplicate produced by a second player character PC2,

FIG. 21 is a diagram illustrating a non-limiting example in which a terrain object OBJ2 edited by a third player character PC3 is moved and used by a second player character PC2,

FIG. 22 is a diagram illustrating a non-limiting example of a reclamation region Ra that is set when a specific object OBJa is arranged,

FIG. 23 is a diagram illustrating a non-limiting example of a game image in a state in which a first player character PC1 is located in a reclamation region Ra,

FIG. 24 is a diagram illustrating a non-limiting example of a game image in a state in which a second player character PC2 is located in a reclamation region Ra,

FIG. 25 is a diagram illustrating a non-limiting example of a section information image displayed on a display 12,

FIG. 26 is a diagram illustrating another non-limiting example of a section information image displayed on a display 12,

FIG. 27 is a diagram illustrating a non-limiting example of a data area set in a DRAM 85 of a main body apparatus 2,

FIG. 28 is a flowchart illustrating a non-limiting example of a game process that is executed in a game system 1,

FIG. 29 is a subroutine indicating a non-limiting example of a player character control process in step S124 of FIG. 25,

FIG. 30 is a subroutine indicating a non-limiting example of an exchange control process in step S150 of FIG. 29,

FIG. 31 is a subroutine indicating a non-limiting example of an other-player character control process in step S125 of FIG. 25,

FIG. 32 is a diagram illustrating a non-limiting example of a data area that is set in a storage unit 105 of a server 102,

FIG. 33 is a flowchart illustrating a non-limiting example of a first half of a process executed in a server 102, and

FIG. 34 is a flowchart illustrating a non-limiting example of a second half of a process executed in a server 102.

### DETAILED DESCRIPTION OF NON-LIMITING EXAMPLE EMBODIMENTS

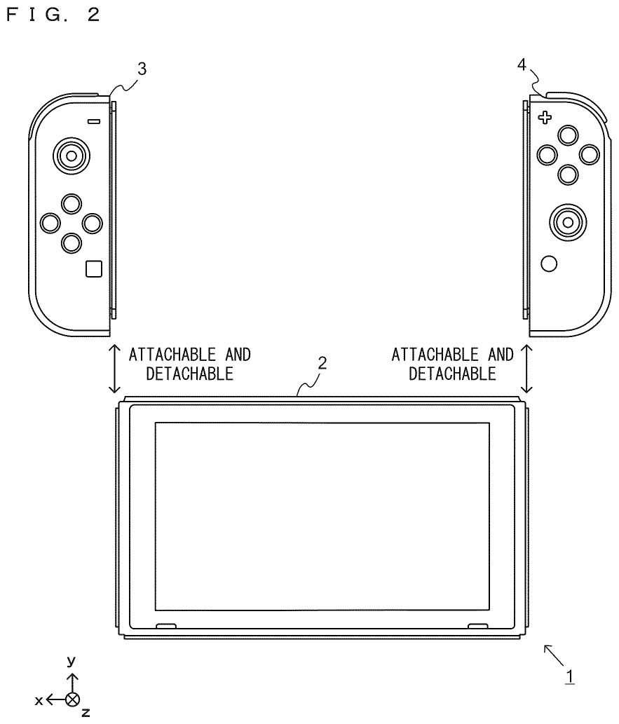

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the following description, a hardware configuration of the game system 1 of the present example is described, and thereafter, the control of the game system 1 of the present example is described.

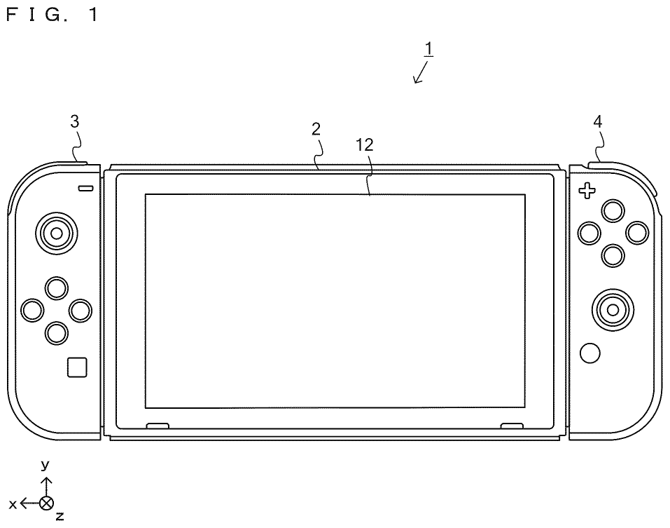

As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

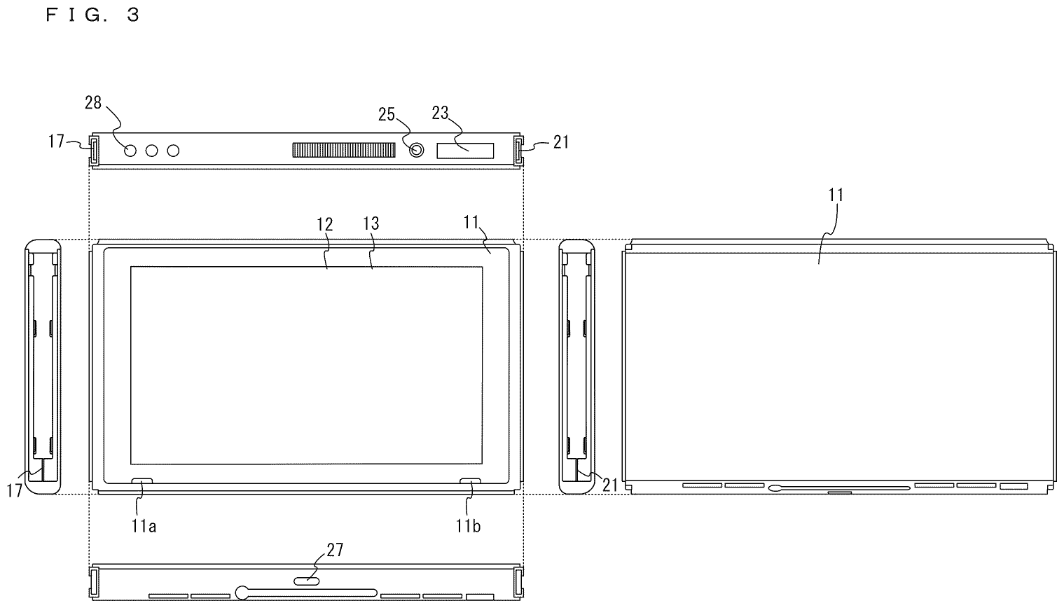

As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

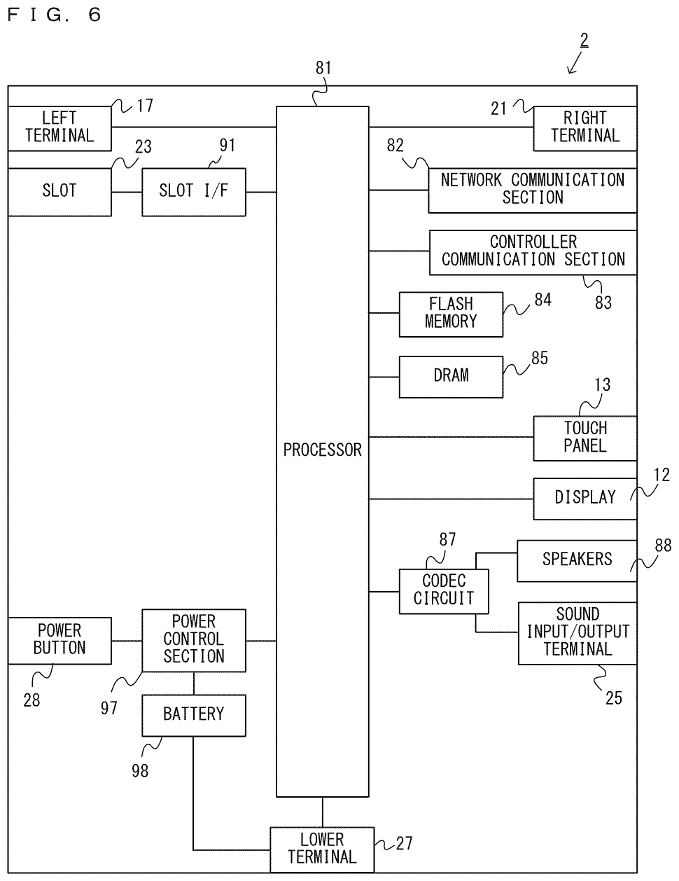

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

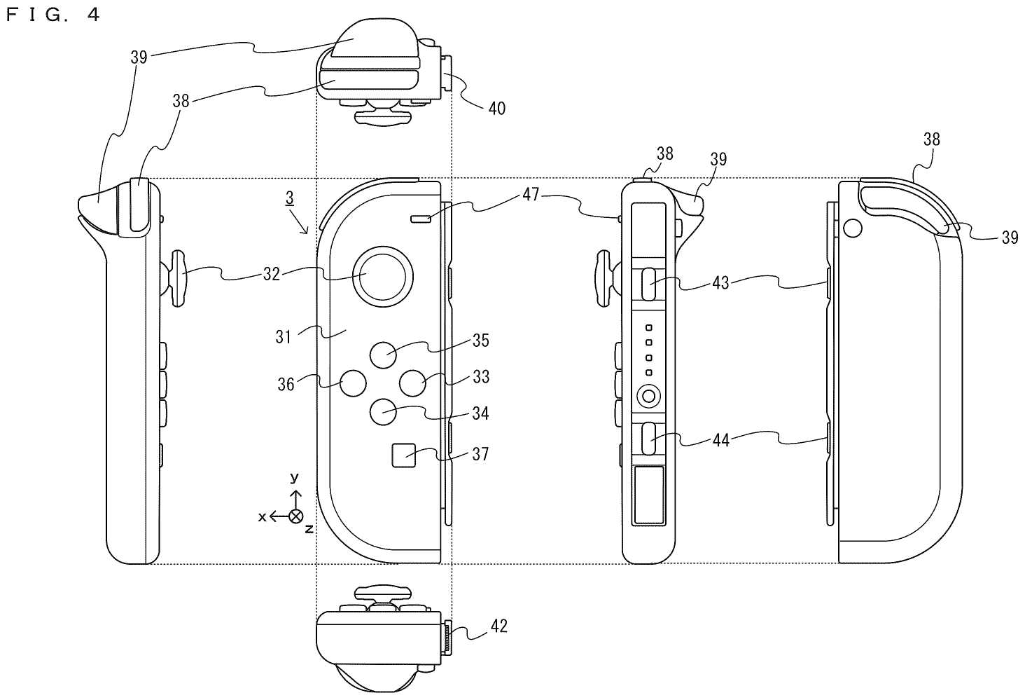

As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

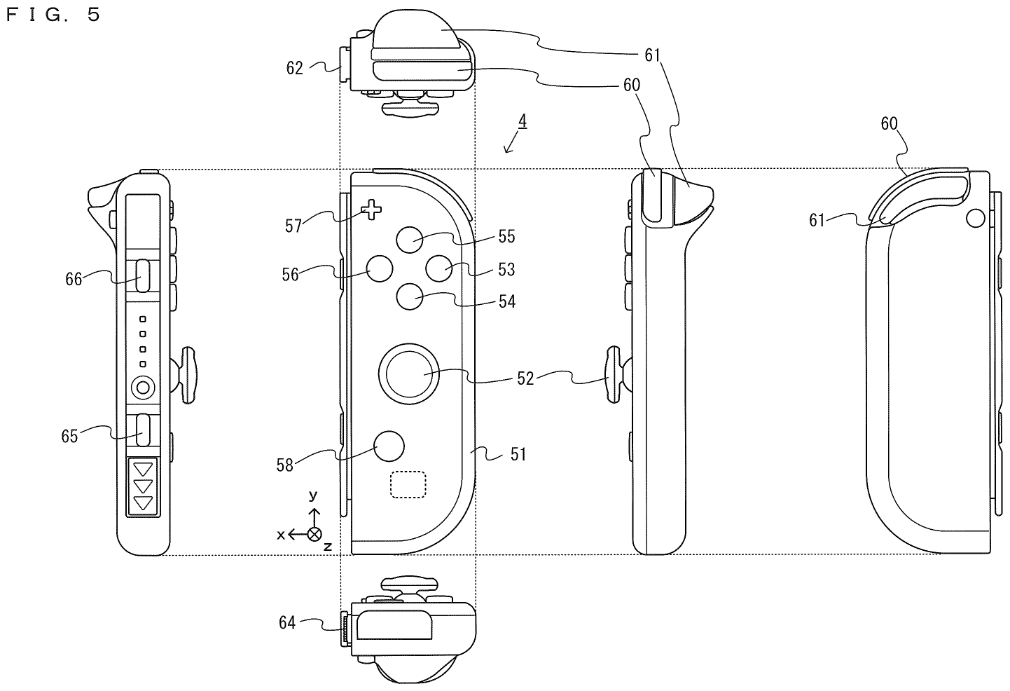

As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to provisionally store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to social data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

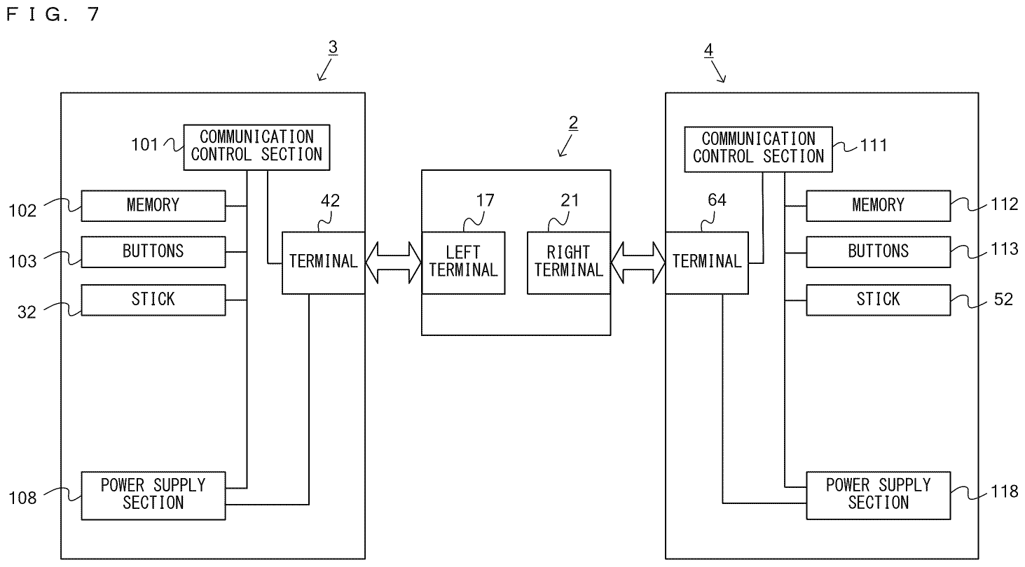

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a game space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player character PC that performs actions in the game space according to the user's operation performed using the operation buttons and sticks.

In the present example, a game in which a plurality of users are allowed to operate respective corresponding player characters so that the player characters perform actions in the same game space can be executed. The game is implemented by a plurality of users utilizing systems in a plurality of forms. As a first example, a game is implemented by a plurality of users operating respective player characters using respective game systems 1, and utilizing an information processing system (e.g., an information processing system in which a plurality of main body apparatuses 2 communicate with each other through a network) in which the network communication section 82 of each game system 1 performs communication through a network using the first communication form. As a second example, a game is implemented by a plurality of users operating respective player characters using respective game systems 1, and utilizing an information processing system (e.g., an information processing system in which a plurality of main body apparatuses 2 directly communicate with each other) in which the network communication section 82 of each game system 1 performs direct communication using the second communication form. As a third example, a game is implemented by inputting operation data produced by a plurality of users operating the left controller 3 and/or the right controller 4 into a single main body apparatus 2, and controlling each user's player character in the same game space using the single main body apparatus 2. In the present example, although, a system having any of the embodiments may be used, an example in which a game is implemented using an information processing system of the first example is used below.

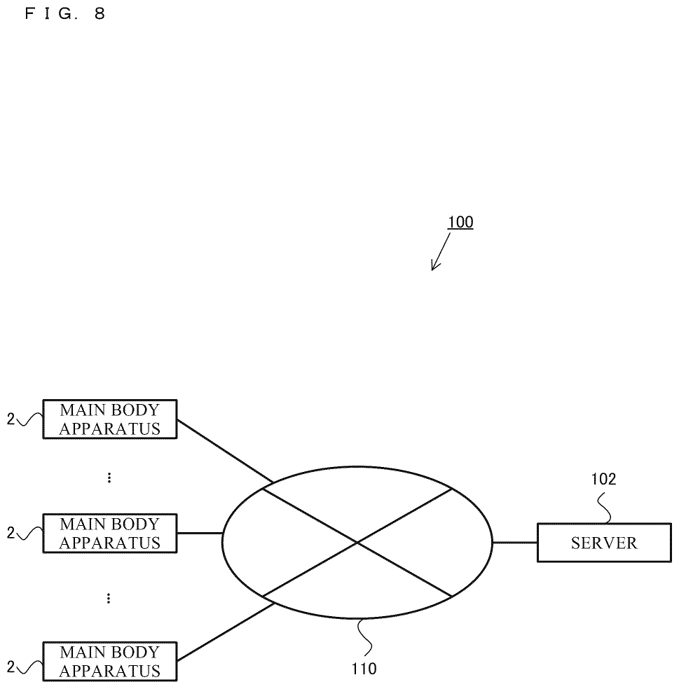

An information processing system of the first example that includes a plurality of game systems 1 and the server 102 will be described with reference to FIG. 8.

As illustrated in FIG. 8, the plurality of game systems 1 (main body apparatuses 2) and the server 102 are connected together through a network 110 to form an information processing system 100. The game system 1 is configured to be able to connect to the network 110 by the above first communication form using wireless or wired communication, and together with the server 102, forms a client-server system. For example, the game system 1 can execute a predetermined application (e.g., a game application). In addition, by executing the predetermined application, the game system 1 can establish connection to the server 102 through the network 110 and communicate with the server 102 through the network 110.

The server 102 has a communication section 103, a control section 104, and a storage section 105. The communication section 103 communicates with the game systems 1 and the like through the network 110 by transmitting and receiving communication packets. As an example, the control section 104 performs a process of managing progression of a game played along with the game systems 1, a process of managing a game space used in a game, a process of managing social data between each user, a process of managing each user's score, a process of managing information about payment or charging, and the like. The control section 104 also establishes a communication link to the game systems 1 and the like through the communication section 103, and performs data transmission control and routing on the network 110. In addition, when a game is played along with a plurality of game systems 1 (e.g., a game in which a plurality of users operate respective corresponding player characters so that the player characters perform actions in the same game space), the control section 104 manages pairing or grouping of game systems 1 that perform the game, and data communication between the game systems 1. The storage section 105 stores a program executed by the control section 104, various types of data required for the process, various types of data required for communication with the game systems 1, and the like. It should be noted that, in the case of a system in which a predetermined log-in process is required for data exchange performed through the network or joining a game, the server may execute an authentication process to determine whether or not a user who is trying to log in is an authorized user. In addition, the server may be a single server machine or may include a plurality of server machines.

In the present example, in the information processing system 100, the game systems 1 exchange operation information through the server 102, so that a networked game in which player characters corresponding to respective users perform actions in the same game space as a shared space is played. The operation information exchanged in the networked game may be information about player characters operated by the users using controllers, information about a game space edited by the player characters' actions, details of operations themselves performed by the users operating the player characters using controllers, or other information with which game progression in the game systems 1 can be understood.

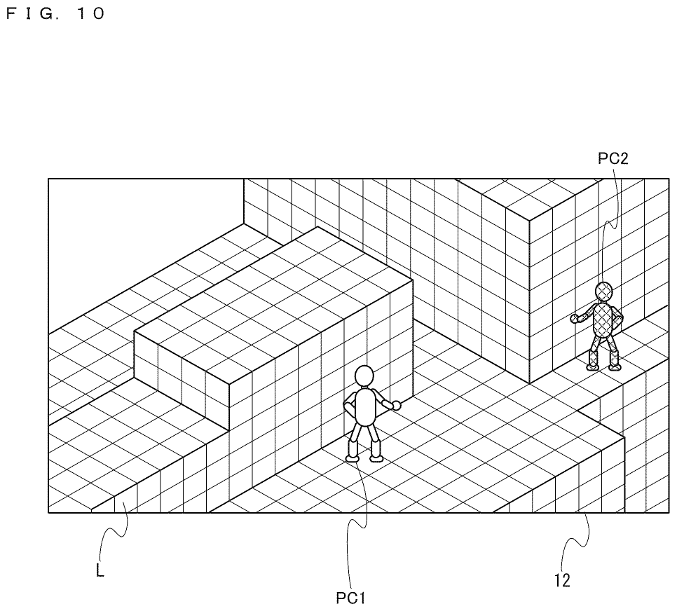

An example game process performed in the game systems 1 included in the information processing system 100 will be outlined with reference to FIGS. 10 to 24. Firstly, in the overview of the example game process, a game space used in the example game process will be outlined with reference to FIG. 10.

In FIG. 10, in the present example, a game field is constituted by a plurality of unit regions. For example, the unit regions are obtained by dividing the game field into squares arranged in a grid pattern as viewed vertically from above. The unit regions have equal sizes. Specifically, in the case in which an x-axis and a z-axis, which are horizontal and orthogonal to each other, and a y-axis, which is vertical, are set in the game field, the game field is divided by a plurality of planes parallel to the xy plane and a plurality of planes parallel to the yz plane into squares in a grid pattern, each of which is a unit region. Thus, in the game field, unit regions are arranged side by side in the horizontal direction (specifically, the front-back direction and the left-right direction) in the game space.

A shape of the game field is determined using terrain objects L (pieces) as units. Terrain objects L are elements constituting the game field. The shape of the game field can be changed by performing movement, addition, removal, or the like on a terrain object L by terrain object L basis. A size of a terrain object L in the horizontal direction of the game space is equal to that of a unit region, and a length of a terrain object L in the vertical direction of the game space is equal to a length of a unit region in the horizontal direction of the game space.

A terrain object L has a rectangular cuboid shape (more specifically, a cubic shape). A game field is constituted by terrain objects L arranged in a grid pattern in the game space. As an example, in the present example, in the game system 1, a parameter related to a terrain object L is set for a coordinate point set in the game space, and for each of a plurality of coordinate points, a parameter indicating whether or not a terrain object L exists at that coordinate point is stored. Thus, in the game system 1, a shape constituted by a plurality of terrain objects L in the game space can be specified by managing whether or not a terrain object L exists at each coordinate point in the game space (i.e., storing the parameter for each coordinate point). It should be noted that the surface of the terrain object L may have roughness, and may have a rounded corner.

In another example, in the game system 1, a parameter may be set for each terrain object L existing in the game space. The parameter set for each terrain object L indicates at least the location of the terrain object L in the game space. Thus, in the game system 1, by managing the location of each terrain object L in the game space (i.e., storing the parameter for each terrain object L), a shape constituted by a plurality of terrain objects L in the game space (the shape of a game field) can be specified. It should be noted that the parameter set for each terrain object L may include other parameters indicating a basic state of the terrain object L or other parameters that vary according to a user's operation. For example, the parameter may include a parameter indicating the durability of a terrain object L, a parameter indicating a period of time that it takes for a terrain object L to automatically disappear, a parameter indicating what kind of object a terrain object L is altered to when destroyed, an attribute of a terrain object L (e.g., whether or not a terrain object L is combustible), or the like. In addition, the parameter may include a parameter indicating what is stored in a terrain object L in the case in which terrain objects L have the function of storing an item, screenshot image, character string, or the like, a parameter indicating the number of times an action has been performed on the stored object (e.g., the number of times the stored item has been removed, the number of times the stored item has been highly rated, or the like), or the like.

In the present example, by a player character PC performing a predetermined action based on a user's operation, a terrain object can be generated, the generated terrain object can be edited, the generated terrain object can be duplicated, and the like. The terrain object generation includes causing a new terrain object to appear in the game space by moving and combining terrain objects L arranged in the game space, and the like. A player character PC that has generated a terrain object (a player character PC that has edited or changed a terrain object first) is referred to as a creator. The editing of a generated terrain object includes updating a terrain object generated by the creator by moving that terrain object, changing the appearance or properties of that terrain object, or newly joining that terrain object to another terrain object, and the like. A player character PC that has edited a terrain object generated by the creator is referred to as an editor. In addition, the duplication of a generated terrain object includes causing a copy of a terrain object generated by the creator to appear in the game space, and the like. A player character PC that has duplicated a terrain object generated by the creator is also referred to as an editor. It should be noted that in the present example, in the case in which a copy of a terrain object is caused to appear, the duplicate may not be an exact duplicate of the terrain object, and may be a partial duplicate of the original terrain object, i.e., the duplicate and the original terrain object may share the same portion of data. An example of the partial duplicate may be a duplicate of a terrain object that is the same as the terrain object, except for the color, luminance, or the like of the original terrain object. In addition, in the present example, the number of objects to be subjected to the predetermined action performed once by a player character PC may be one of a plurality of objects (terrain objects, and decorative objects described below), or a plurality of objects at the same time. In addition, in the present example, a terrain object generated by the creator may be able to be duplicated in the same game space by the same creator. In that case, the editor of a terrain object duplicated by the creator is the creator.

It should be noted that editing of a terrain object generated by the creator by moving the terrain object, which is an example of editing of a terrain object generated by the creator, includes at least an embodiment in which a parameter of a terrain object is updated as described below. As an example, in the case in which a parameter related to a terrain object is set for coordinate points in the game space, when a terrain object is moved, the parameter for a coordinate point in the game space is changed, and information indicating a user (a player character PC) who has updated the parameter for the coordinate using the terrain object is embedded and stored in the terrain object. As another example, in the case in which a parameter indicating the location of a terrain object in the game space is set, when a terrain object is edited by being moved, the parameter indicating the location of the terrain object in the game space is updated to indicate the location where the terrain object has been arranged after being moved.

In the present example, by rewriting and updating the parameter so as to remove a portion of a plurality of terrain objects L constituting a terrain to edit a state of the terrain objects L, the shape of the terrain can be easily changed. In addition, in the case in which a terrain is added, as in the case in which terrain objects L are removed, by rewriting and updating the parameter so as to arrange terrain objects L on a terrain object L by terrain object L basis to edit a state of the terrain objects L, the shape of the terrain can be easily changed. Thus, in the present example, by rewriting the parameter, terrain objects in the game space can be easily generated or edited, for example. As a first example, in the case in which a terrain object is newly generated by a player character PC editing a terrain by moving or joining a portion of a terrain, the parameter is set for the generated terrain object. As a second example, in the case in which the shape of a terrain is edited by, for example, a player character PC hitting the terrain to destroy a terrain object L (a terrain object is edited), the parameter is updated for the removed terrain object L. As a third example, in the case in which a terrain object already generated in the game space is duplicated and added to the game space by a player character PC (a terrain object is duplicated), the parameter is set for the duplicate of the terrain object. Thus, terrain objects serve as a terrain piece or terrain block that can be used to generate, edit, duplicate, and the like a terrain in the game space.

In addition, in the present example, a terrain in the game space may be constituted by a plurality of types of terrain objects having different properties or appearances. In that case, the parameter may include any data that can specify the properties or appearance of an arranged terrain object L. For example, the parameter may include data that can specify properties including a material such as sand, rock, soil, or ice, brittleness, joinability to other objects, or the like, or data that can specify appearance indicating texture or the like used for a terrain object, or the like, whereby the states of a plurality of types of terrain objects can be set. In that case, by a player character PC editing the properties or appearance of a terrain object, the parameter for the edited terrain object may be able to be updated.

Terrain objects may be joined to other neighboring terrain objects, so that an integrated terrain object is generated or edited. For example, by a player character PC performing a predetermined action, a plurality of terrain objects that are a target of the action may be joined together to be integrated. In that case, the parameter may include data that can be used to determine whether or not terrain objects are joined together to be integrated or the like, thereby making it possible to set whether or not a terrain object is joined to and integrated with another terrain object. In the present example, the generation and editing of a terrain object include generation and editing involving joining and integrating the terrain object to and with another terrain object, and generation and editing involving disintegration. As a first example, in the present example, when a terrain object is joined to and integrated with another neighboring terrain object, these terrain objects can be moved (e.g., raised) with the positional relationship (arrangement) thereof maintained. As a second example, in the present example, when a terrain object is joined to and integrated with another neighboring terrain object, the orientations of these terrain objects can be changed by, for example, raising the terrain objects with the positional relationship (arrangement) thereof maintained. As a third example, when a terrain object is joined to and integrated with other neighboring terrain objects, then if, even while at least one of these terrain objects is not supported by any other object (i.e., no object exists under that terrain object), another one of the terrain objects is supported from below, the positional relationship (arrangement) of the terrain objects can be maintained without any objects that are not supported from below falling.

In addition, when a terrain object L is destroyed by a player character PC to be removed from the game space, an item corresponding to the terrain object L (e.g., a card item indicating a material for the terrain object L) may be able to be caused to appear in the game space. In the present example, the changing of a state of the game space and the editing of a terrain object may include removing the terrain object L from the game space to cause the item to appear. In addition, the generation of a terrain object may include generating the terrain object from the item, and arranging the terrain object generated from the item in the game space.

In addition, other states of a terrain object may be able to be edited. For example, the editing of a terrain object may include changing a shape or type of the terrain object itself arranged in the game space, changing or rotating the orientation of the terrain object arranged in the game space, changing the durability or properties (movability, joinability, or the like) of the terrain object arranged in the game space, and the like. In the present example, the parameter may be used to identify these states, and the parameter corresponding to a terrain object may be updated by rewriting the parameter.

In the present example, a game in which a plurality of users operate and move respective corresponding player characters PC is performed using a game space constituted by a plurality of terrain objects L. For example, in the example of FIG. 10, a first player character PC1 and a second player character PC2 are arranged on a terrain constituted by a plurality of terrain objects L. The first player character PC1 corresponds to a user of a game system 1 (hereinafter referred to as a first user), and is operated in the game space by the first user's operation of the left controller 3 and/or the right controller 4 of the game system 1. The second player character PC2 corresponds to a user of another game system 1 (hereinafter referred to as a second user), and is operated in the same game space in which the first player character is arranged, by the second user's operation of the left controller 3 and/or the right controller 4 of the another game system 1.

A plurality of users are each allowed to change a state of the game space by operating a corresponding player character PC to generate, edit, duplicate, or the like a terrain object, which is an example of a content in the game space. For example, by causing the first player character PC1 to perform an action based on the first user's operation input, a terrain object L corresponding to a location in the game space corresponding to the action can be moved, a terrain object L corresponding to a location in the game space corresponding to the action can be removed, a terrain object can be newly arranged at a location in the game space corresponding to the action, or a generated terrain object can be duplicated. In addition, by causing the second player character PC2 to perform an action based on the second user's operation input, a state of the same game space can be changed in a manner similar to that for the first player character PC1.

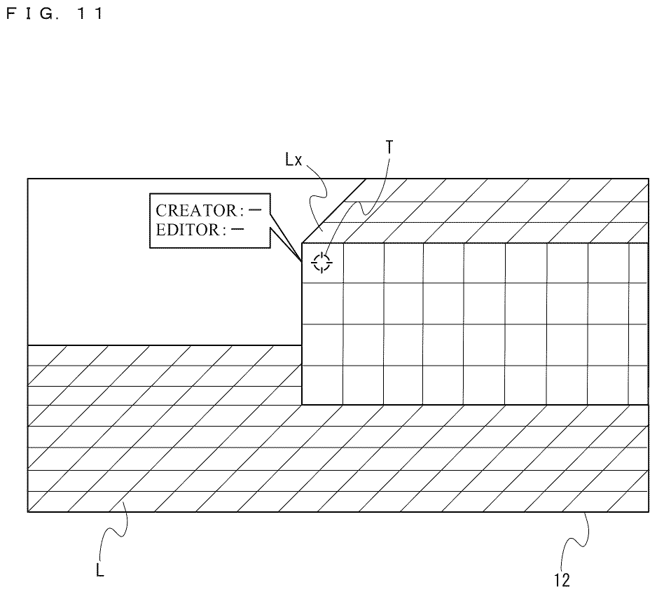

In the present example, the parameter corresponding to each terrain object that has been generated, edited, duplicated, or the like may include data indicating a creator (originator) or editor (arranger). Here, the creator indicates a player character PC that has newly generated, or edited first, a terrain object in the game space. The editor indicates a player character PC that has edited or duplicated the generated terrain objects last. The creator and the editor of a terrain object can be viewed according to a predetermined operation performed by a user. For example, as illustrated in FIG. 11, when a user wants to view the creator and the editor of a terrain object Lx, the creator and the editor of the terrain object Lx are displayed by aligning a displayed aiming point T with the terrain object Lx. In the example of FIG. 11, the terrain object Lx is one of original terrain objects L that have not been generated, edited, duplicated, or the like by any users, and therefore, blank fields are displayed, indicating that no creator or editor has been set for the terrain object Lx. In another example, a creator and an editor may be displayed by a user performing an operation instruction to view a menu screen. For example, by a user performing an operation instruction to view a menu screen with the displayed aiming point T aligned with the terrain object Lx, for which the user wants to view the creator and the editor, the creator and the editor of the terrain object Lx may be displayed on the menu screen.

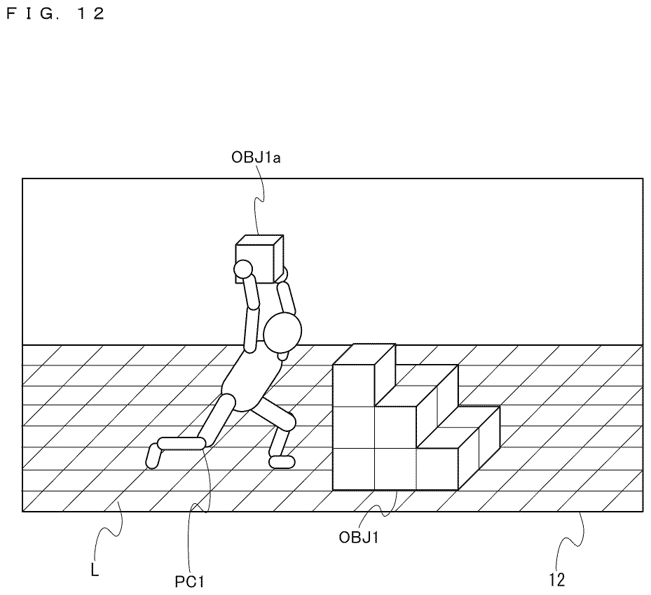

As illustrated in FIG. 12, the first player character PC1 moves and joins a plurality of terrain objects according to the first user's operation to generate a terrain object OBJ1 in the game space. Specifically, the first player character PC1 performs an action of joining a terrain object OBJ1a to the terrain object OBJ1 that has already been generated by the first user according to their own operation, to generate the staircase-like terrain object OBJ1 in the game space. The first player character PC1 can raise and move, or store the terrain object OBJ1a by performing a predetermined action. By the first player character PC1 moving the terrain object OBJ1a in the game space while raising or storing the terrain object OBJ1a, the terrain object OBJ1a is moved together with the first player character PC1, so that the terrain object OBJ1a can be arranged on or joined to another object by a predetermined action. Here, that the first player character PC1 stores an object means that the first player character PC1 is allowed to carry an item or the like representing the object without holding or wearing the object, for example. At this time, the stored object may not be displayed in the game space. The stored object can be arranged or used (including wearing and holding) in the game space according to the first user's operation input, basically in appropriate situations. As an example, for example, the first player character PC1 may store an object by putting the object into a container such as a pouch or item box. It should be noted that such a container may not be displayed. In addition, the container such as a pouch or item box may not exit in the game space, and only the function of storing an object may exist.

It should be noted that the terrain objects OBJ1a and OBJ1 may be a portion of terrain objects L that are previously arranged in the game space during the start of a game, may be previously arranged on other terrain objects L, may be arranged at a predetermined location when a player level reaches a predetermined level or a predetermined acquisition condition is satisfied, e.g., a mission is achieved, or may be arranged when another character drops the object, or another character is beaten.

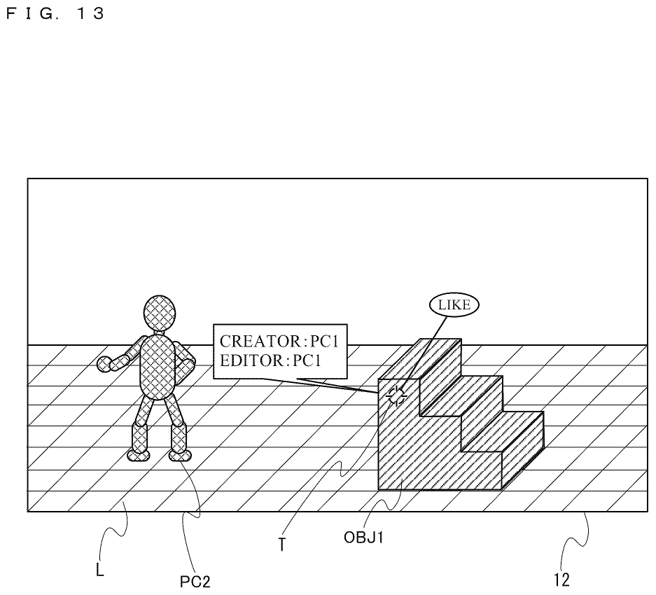

As illustrated in FIG. 13, when the aiming point T is displayed, overlaying the terrain object OBJ1, so that the creator and the editor of the terrain object OBJ1 are to be displayed, the first player character PC1 is displayed as both of the creator and the editor of the terrain object OBJ1. It should be noted that in the example of FIG. 13, the first player character PC1 is the creator and the last editor of the terrain object OBJ1, and is therefore displayed as both of the creator and the editor. In another example, the first player character PC1 may be only displayed in the creator field with the editor field left blank.

In the present example, a fourth player character PC4 may perform an action of joining another terrain object OBJ1b to the terrain object OBJ1, for which the first player character PC1 is displayed as the creator and the editor, so that the terrain object OBJ1b is joined to the terrain object OBJ1. In this case, the creator and the editor of a portion of the resultant terrain object corresponding to the original terrain object OBJ1 may still be the first player character PC1. The fourth player character PC4 may be displayed as both of the creator and the editor of a portion of the resultant terrain object corresponding to the newly joined terrain object OBJ1b. In other words, in the present example, instead of only a single set of a creator and an editor being recorded for a mass of terrain objects including the terrain object OBJ1 and the terrain object OBJ1b joined thereto, a creator and an editor may be recorded for each terrain object included in the mass of terrain objects. In another example, when the terrain object OBJ1b is joined to the terrain object OBJ1 by the fourth player character PC4's action, it may be considered that a mass OBJ2 of terrain objects (regarded as a single terrain object OBJ2) is newly generated by the terrain object OBJ1b being joined to the terrain object OBJ1, and the fourth player character PC4 may be recorded as the creator and the editor of the terrain object OBJ2. In another example, when the terrain object OBJ1b is joined to the terrain object OBJ1 by the fourth player character PC4's action, it may be considered that editing is performed so as to join the terrain object OBJ1b to the terrain object OBJ1, and the fourth player character PC4 may be recorded as the editor of the terrain object OBJ1.

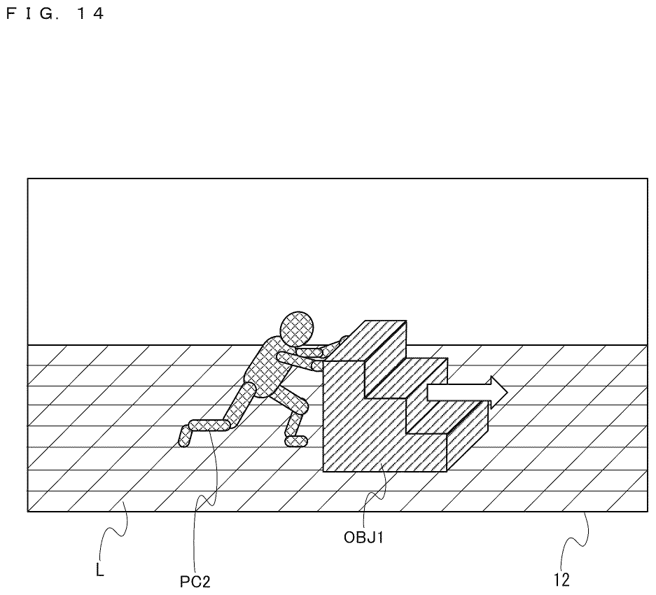

As illustrated in FIG. 14, the second player character PC2, which is not the creator of the terrain object OBJ1, edits the terrain object OBJ1 by performing an action of pushing the terrain object OBJ1 on the ground (terrain objects L) in the game space according to the second user's operation, so that the terrain object OBJ1 is moved in the game space in the pushing direction to change the location. This is an example of a predetermined action by which the second player character PC2 edits a terrain object created by the first player character PC1. When a terrain object has thus been edited, a player character that has performed the editing is set as the editor of the terrain object.

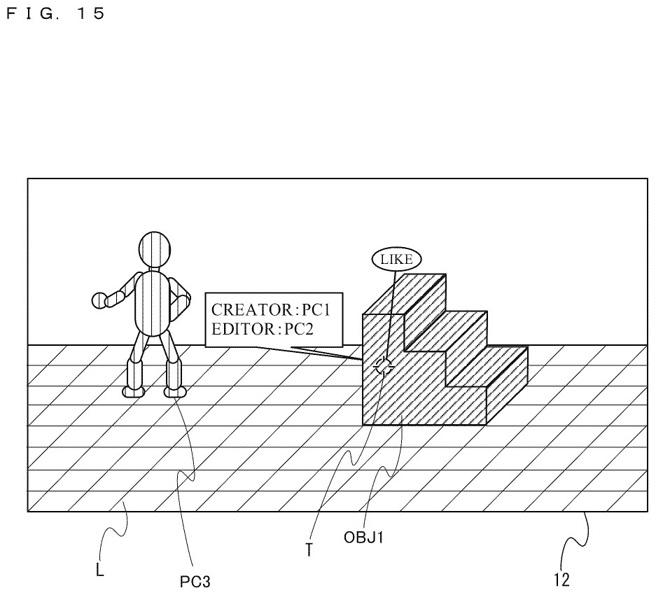

For example, as illustrated in FIG. 15, when the aiming point T is displayed and aligned with the edited terrain object OBJ1, so that the creator and the editor of the terrain object OBJ1 are to be displayed, the first player character PC1 is displayed as the creator of the terrain object OBJ1 and the second player character PC2 is displayed as the editor of the terrain object OBJ1.

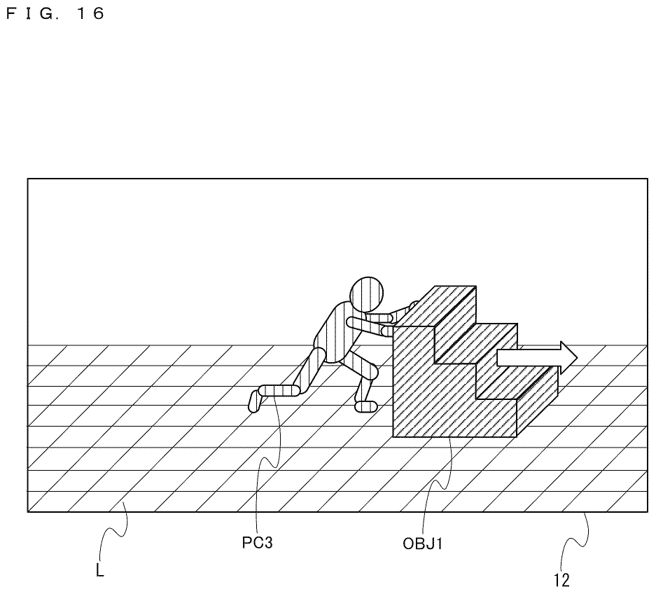

As illustrated in FIG. 16, a third player character PC3, which is not the creator or editor of the terrain object OBJ1, edits the terrain object OBJ1 for the second time by pushing the terrain object OBJ1 according to a third user's operation to change the location of the terrain object OBJ1. When a terrain object has thus been edited a plurality of times, a player character that has edited the terrain object last (in this case, the third player character PC3) is set as the editor of the terrain object.

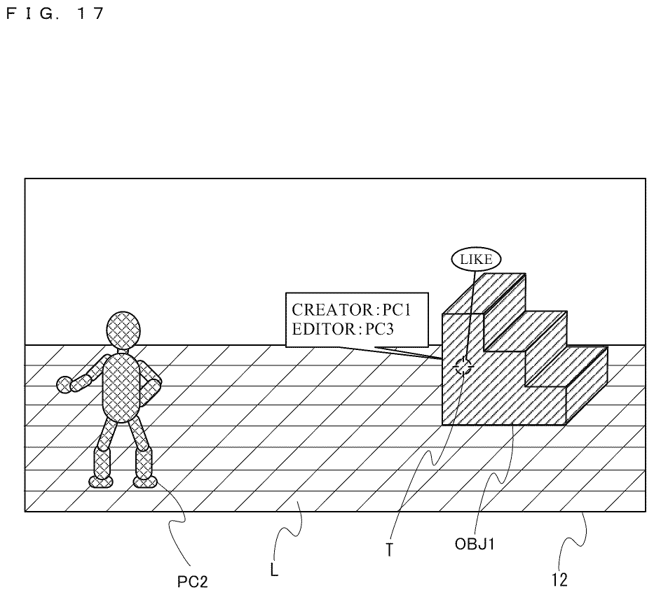

For example, as illustrated in FIG. 17, after the terrain object OBJ1 has been edited two times, when the aiming point T is displayed and aligned with the terrain object OBJ1, so that the creator and the editor of the terrain object OBJ1 are to be displayed, the first player character PC1 is still displayed as the creator of the terrain object OBJ1, while the third player character PC3 is displayed as the new editor of the terrain object OBJ1 instead of the second player character PC2.

In addition, in the present example, other objects different from terrain objects may be able to be generated, edited, duplicated, and the like based on a player character PC's predetermined action in the game space. In that case, for other objects that have been subjected to generation, editing, duplication, or the like, the parameter corresponding to each object may include data indicating the creator and the editor. For example, decorative objects that are another example of a content that can be put on or worn by a player character PC in the game space may be able to be generated, edited, duplicated, and the like based on the player character PC's predetermined action in the game space.

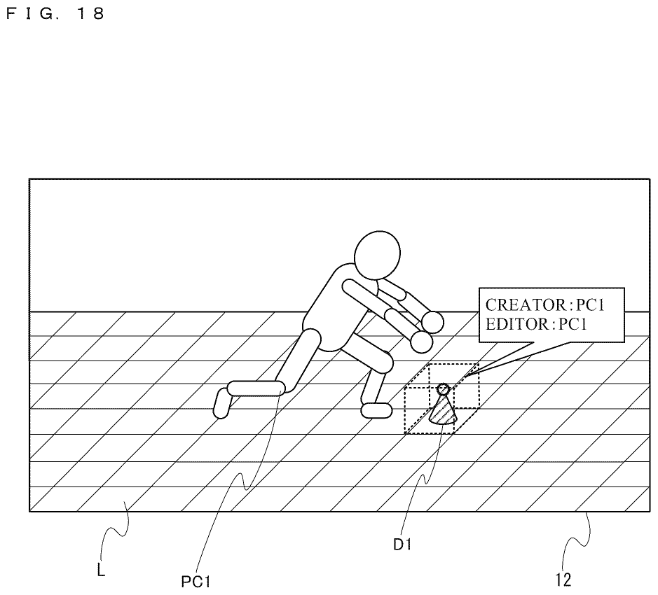

For example, as illustrated in FIG. 18, the first player character PC1 generates a decorative object D1 that the player character PC can wear on its head according to the first user's operation, and arranges the decorative object D1 on a terrain in the game space. Here, the first user that operates the first player character PC1 can generate a decorative object by replacing and editing a decorative part having a plurality of types of parts. In addition, as the player level increases, a decorative part including a larger number of types of parts can be replaced and edited. Therefore, a greater variety of decorative objects can be generated and caused to appear in the game space as the player level increases. In the example of FIG. 18, for the decorative object D1, which has thus been generated and arranged, the first player character PC1 is displayed as both of the creator and the editor. As another example, the first user may be allowed to generate a decorative object constituted by parts the number of which depends on the player level, by performing a predetermined operation, or may generate a decorative object having a size depending on the player level and/or a decorative object having an elaborateness depending on the player level, and cause the objects to appear in the game space.

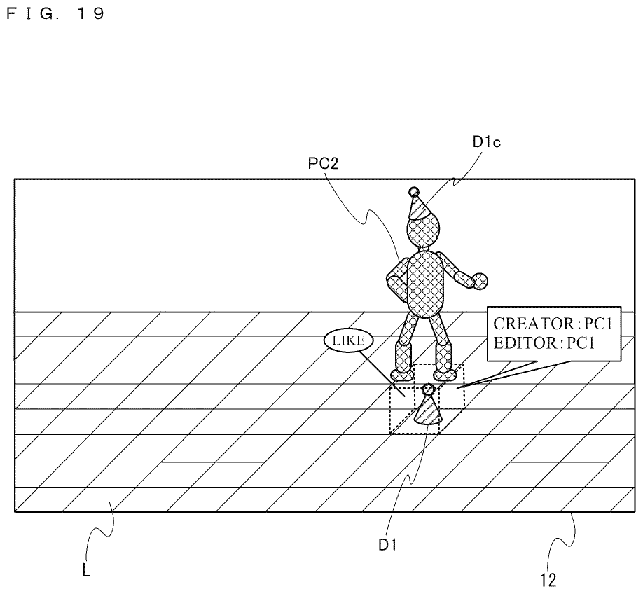

The decorative object D1 thus arranged in the game space can be worn or stored by another player character PC picking up the decorative object D1 or taking a duplicate of the decorative D1 according to another user's operation. For example, as illustrated in FIG. 19, the second player character PC2, which is not the creator of the decorative object D1, takes a decorative object D1c that is a duplicate of the decorative object D1 arranged in the game space, and wears the decorative object D1c on its head, based on a predetermined action according to the second user's operation (e.g., an action performed according to the second user's operation of pressing down the operation button 53 (A-button) with the second player character PC2 standing on the decorative object D1). When a decorative object generated by another player character is thus duplicated, a player character that has performed the duplication is set as the editor of the decorative object. It should be noted that in the present example, a decorative object generated by the creator may be able to be duplicated by the same creator in the same game space. In that case, the creator is also the editor of a duplicate of the decorative object generated by the creator.

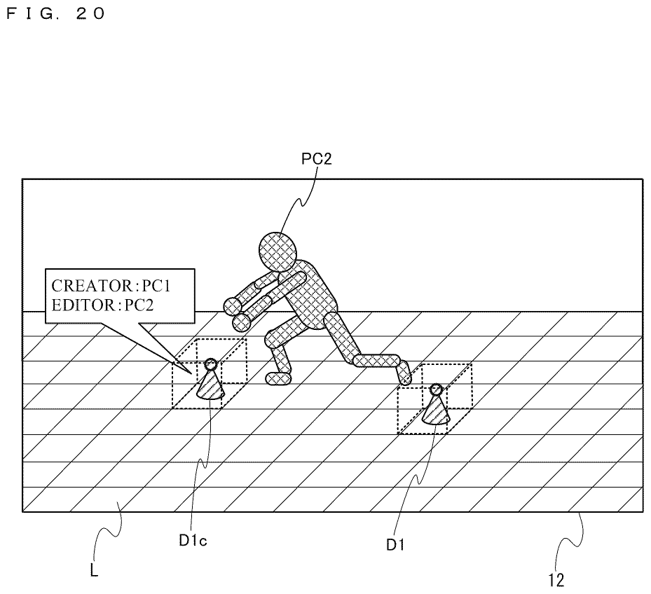

As illustrated in FIG. 20, the second player character PC2 arranges the duplicate decorative object D1c on a terrain in the game space according to the second user's operation. In the example of FIG. 20, for the duplicate decorative object D1c thus arranged, the first player character PC1 is still displayed as the creator of the decorative object D1c, and the second player character PC2 is displayed as the editor of the decorative object D1c. It should be noted that the duplicate decorative object D1c may be further edited or duplicated by a player character PC. In that case, the creator remains unchanged, and a player character PC that has performed editing or duplication last is set as the editor.

It should be noted that in the present example, generation of an object (a terrain object, a decorative object) may include: causing an object that does not exist in the game space to appear, so that the object is newly arranged in the game space; and moving and processing an object that is initially arranged in the game space (i.e., an object for which a creator or an editor has not been recorded), so that the object is arranged in the game space. In the former case, a player character PC may receive an object from another character based on an action between the player character PC and the another character, or a player character PC may purchase or be presented with an object through a shop or the like set in a game. In that case, when the player character PC arranges the acquired or purchased object in the game space (generation of the object), the player character PC is recorded as the creator of the object. In the latter case, when a player character PC edits (e.g., moves or processes) first an object that has initially been arranged in the game space and for which a creator has not been recorded, the player character PC is recorded as the creator of the object.

In addition, in the present example, the editing of an object (a terrain object, a decorative object) is performed by a player character PC changing the location, orientation, shape, appearance, properties, size, or the like of the object, a player character PC picking up the object in the game space, a player character PC receiving the object from another character, or the like. The editing of an object by changing the location of the object may be performed by a player character PC raising the object. Although in the present example, in the case in which an object generated by a creator is edited or duplicated, a player character PC that has performed the editing or duplication is recorded as the editor, a player character PC that has edited or duplicated first an object for which a creator had not been recorded may be recorded as the creator of the object.

In the present example, users involved in a social activity between player characters PC (uses operating player characters PC) are given social points based on the social activity. For example, when a user (first user) is recognized as having performed any action on another user, social points are given to the another user (second user). In this case, social points may be automatically given to the second user according to an action of a player character PC operated by the first user, or social points may be given to the second user in response to the first user's operation.

As a first example, first social points are given to an object that has been generated, edited, duplicated, or the like by a player character PC, or said player character PC itself in response to a user who operates another player character PC performing an operation of giving a high rating (“like”), where the object that has been generated, edited, duplicated, or the like by the player character PC, or said player character PC itself, is evaluated. For example, in the example of FIG. 13, a predetermined number of first social points (e.g., +1 point) are given as a high rating (“like”) to the first player character PC1, which is the creator of the terrain object OBJ1, by the second user, who operates the second player character PC2, performing an operation of pressing down a predetermined operation button (e.g., any of the operation buttons 33 to 36 (cross button)) while performing an operation of displaying and aligning the aiming point T with the terrain object OBJ1 generated by the first player character PC1 (e.g., an operation of moving and aligning the aiming point T by performing an operation of tilting the analog stick 35 while pressing down the operation button 39 (ZL button)). Although in the example of FIG. 13, the first player character PC1 is also set as the editor of the terrain object OBJ1, since the first player character PC1 is also set as the creator, first social points for the editor may not be given to the first player character PC1, or alternatively, first social points for the creator and first social points for the editor may both be given to the first player character PC1. In addition, in the example of FIG. 15, a predetermined number of first social points are given as a high rating (“like”) to each of the first player character PC1, which is the creator of the terrain object OBJ1, and the second player character PC2, which is the editor of the terrain object OBJ1, by the third user, who operates the third player character PC3, performing an operation of pressing down a predetermined operation button while performing an operation of displaying and aligning the aiming point T with the terrain object OBJ1 that has been edited by the second player character PC2 after having been generated by the first player character PC1. In the example of FIG. 17, a predetermined number of first social points are given as a high rating (“like”) to each of the first player character PC1, which is the creator of the terrain object OBJ1, and the third player character PC3, which is the last editor of the terrain object OBJ1, by the second user, who operates the second player character PC2, performing an operation of pressing down a predetermined operation button while performing an operation of displaying and aligning the aiming point T with the terrain object OBJ1 that has been edited last by the third player character PC3 after having been generated by the first player character PC1. Although in the example of FIG. 15, the terrain object OBJ1 has also been edited by the second player character PC2, the second player character PC2 is not the last editor, and therefore, first social points for the editor may not be given to the second player character PC2. It should be noted that in another example, in addition to the creator and the editor, first social points may also be given to a player character PC that has given a high rating (“like”) to the creator and the editor (in the example of FIG. 13, the second player character PC2).

It should be noted that in the first example, first social points may be given in response to a user's operation. As an example, when a player character PC (first player character PC) is arranged on a terrain object OBJ that has been generated, edited, duplicated, or the like by another player character PC (second player character PC), a predetermined number of first social points may be given as a high rating (“like”) to each of the creator and the editor of the terrain object OBJ directly below the first player character PC in response to a user who operates the first player character PC performing a predetermined operation (e.g., an operation of pressing down the operation button 34 (downward button)). As another example, when a first player character PC performs a predetermined action on a second player character PC (e.g., an action of talking to the second player character PC, an action of handing an article to the second player character PC, an action of touching the second player character PC, etc.) according to a user's operation, a predetermined number of first social points may be given as a high rating (“like”) to the second player character PC in response to the user's operation.

As a second example, when an object that has been generated, edited, duplicated, or the like by a player character PC is used by another player character PC, first social points are automatically given to the player character PC that has performed the generation, editing, duplication, or the like. For example, in the example of FIG. 19, when the second player character PC2 performs an action of duplicating or using (putting on or wearing) the decorative object D1 generated by the first player character PC1, a predetermined number of first social points are automatically given as a high rating (“like”) to the first player character PC1, which is the creator of the decorative object D1. Although in the example of FIG. 19, the first player character PC1 is also set as the editor of the decorative object D1, since the first player character PC1 is also set as the creator of the decorative object D1, the first player character PC1 may not be given first social points for the editor, or the first player character PC1 may be given both of first social points for the creator and first social points for the editor. As in the example of FIG. 20, when the decorative object D1c that is a duplicate produced by duplication performed by the second player character PC2 is further duplicated or used by another player character PC, a predetermined number of first social points are given as a high rating (“like”) to each of the first player character PC1, that is the creator of the decorative object D1c, and the second player character PC2, which is the editor of the decorative object D1c.

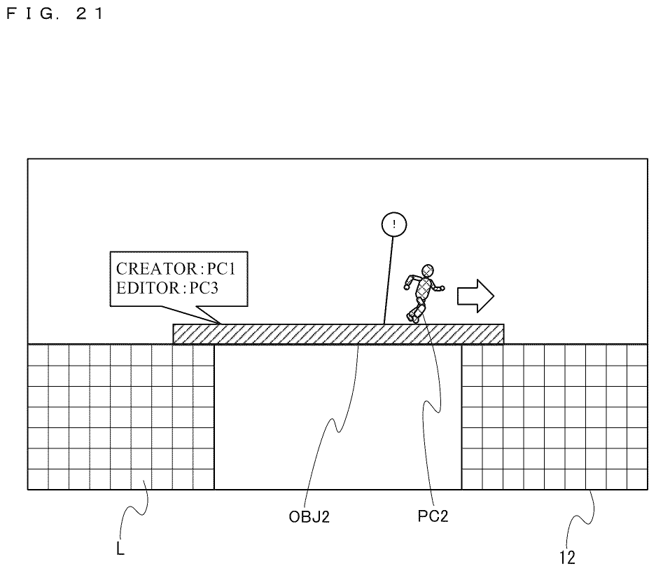

It should be noted that in the second example, second social points may also be automatically given according to a player character PC's action in another embodiment. For example, when a player character PC performs a predetermined action on a terrain object that has been generated, edited, duplicated, or the like by another player character PC, a predetermined number of second social points are given to the creator and the editor of the terrain object. For example, as illustrated in FIG. 21, a terrain object OBJ2 that has been generated by a first player character PC1 and edited last by a third player character PC3 is provided in the shape of a bridge in the game space. When a second player character PC2 has moved on and used the terrain object OBJ2 at least a predetermined number of successive times, a predetermined number of second social points are given to each of the first player character PC1, which is the creator of the terrain object OBJ2, and the third player character PC3, which is the editor of the terrain object OBJ2. As an example, when the second player character PC2 has moved on the terrain object OBJ2, then if the unit region at the destination of movement of the second player character PC2 has been the terrain object OBJ2 a predetermined number of successive times (e.g., four successive times, or may be at least five successive times), second social points are given. In another example, each time the second player character PC2 moves on the terrain object OBJ2 by a unit distance (e.g., each time the second player character PC2 moves on the terrain object OBJ2 by a distance corresponding to one unit region), a predetermined number of second social points may be given to each of the first player character PC1, which is the creator of the terrain object OBJ2, and the third player character PC3, which is the editor of the terrain object OBJ2. In still another example, based on a period of time for which the second player character PC2 has moved on the terrain object OBJ2, a predetermined number of second social points may be given to each of the first player character PC1, which is the creator of the terrain object OBJ2, and the third player character PC3, which is the editor of the terrain object OBJ2. As another example, when the first player character PC1 jumps on a jump ramp that has been generated, edited, duplicated, or the like by another player character PC, second social points may be given to the another player character PC.

It should be noted that second social points may not be able to be used to increase the player level, as is different from first social points. In another example, second social points may be able to be used together with first social points to increase the player level.

Thus, in the present example, social points (first social points, second social points) are given to not only the creator but also the editor of an object (a terrain object, a decorative object). When an object has been edited or duplicated a plurality of times, a player character PC that has edited or duplicated the object last is recorded as the editor, and the record of the creator of the object is not changed. Therefore, the creator can obtain social points more advantageously than the editor. It should be noted that in another example, when an object has been edited or duplicated a plurality of times, all player characters PC that have edited or duplicated the object may be recorded as the editor, and social points may be given to all of the recorded editors. In another example, when an object has been edited or duplicated a plurality of times, not only an editor that has edited or duplicated last, but also player characters PC that have edited or duplicated last a predetermined number of times, may be recorded as the editor, and social points may be given to all of the recorded editors.

Social points are accumulated for each player character PC and are managed by the main body apparatus 2 and/or the server 102. Based on the accumulated social points (particularly, first social points, or may be the sum of first social points and second social points), a player character PC given the accumulated social points (and the user operating the player character PC) is given a predetermined reward (privilege). For example, the accumulated social points can be consumed in predetermined units based on an operation input performed by the user who operates a player character PC given the accumulated social points, and the player level of the player character PC can be increased automatically based on the consumption, or manually according to the user's operation. When the player level increases, the player character PC is given the privilege of acquiring a function or having an improved ability. As an example, when the player level increases, the player character PC is given a privilege, e.g., the types of decorative objects that can be generated by the player character PC increase (e.g., the player character PC transitions from a state in which generation of a decorative object for the entire body is limited to a state in which generation of a decorative object for the entire body is allowed), the number of parts that can be used by the player character PC to generate a decorative object increases, the upper limit of social points that can be given to another player character PC increases, or the like. In this example, when the accumulated social points increase, a decorative object having a greater pulling power can be generated, so that a game in which a game cycle in which the number of accumulated social points is expected to further increase is repeatedly performed can be implemented. In addition, in the present example, even the editor of a decorative object or terrain object can participate in such a game cycle, and therefore, a game cycle having many variations and a wide scope can be implemented. For example, even when an object as it was generated by a user is less likely to be highly rated, then if the object is edited or duplicated by another user, so that the object is likely to be highly rated, the editor can be given an appropriate reward. As another example, in the case in which a naming right is set for an object or area (e.g., the unit region or a section described below) in the game space, when the player level increases and/or social points are consumed, the privilege of obtaining the naming right may be given to the player character PC.

It should be noted that the number of social points given to a creator may be different from the number of social points given to an editor. For example, the number of social points given to a creator may be higher than the number of social points given to an editor.

In the present example, in the case in which a player character PC which is to be given social points for an object is included in the creator or editor of the object, the player character PC is not given social points. Even in this case, a creator or editor that is not the player character PC may be given social points.

In addition, when the player level increases, social points may not be consumed at the same time. For example, when the accumulated social points (e.g., first social points) reach a threshold, the player level may be automatically or manually increased without consumption of the social points.

In addition, in another example, social points given to a creator and social points given to an editor may be different parameters. In that case, a reward (privilege) given based on creator social points given to a creator may be different from a reward (privilege) given based on editor social points given to an editor. As an example, when creator social points are accumulated, a player character PC given the social points (and the user operating the player character PC) may be given a trophy or title as a privilege. As another example, based on creator social points, a creator given the social points may be given a predetermined item as a privilege. It should be noted that creator social points given to a creator may be given separately from social points given to a creator as described above, or may be given instead of said social points.

In addition, the above parameter and information may be managed for each user in the server 102. For example, the server 102 may manage a user ID that is an identifier assigned to each user, accumulated social points (first social points, second social points) given to a player character PC operated by a user, the player level of a player character PC, and the like, as user information, for each user. In addition, the user information managed by the server 102 may be able to be presented to other users. For example, when a process of recording a user and another user as friends is performed, the user information of these users may be provided to each other through the server 102.

In addition, it may be possible to check a source user that has given social points to a player character PC operated by a user, or a player character PC operated by said user. For example, when a user performs an operation instruction to view a social point list during a game, a social point list indicating the user, first and second social points given to a player character PC operated by the user, and the history of source users that have given these points. For example, the history may be obtained by requesting to the server 102, or data managed in the game system 1 may be used. The history may include an object or character for which social points have been given (e.g., for which terrain object or decorative object social points have been given), the date and time on which an action for which social points are given has been performed, a target user to which a player character PC operated by a user has given social points, and the player character PC operated by the user, which may be able to be checked.

In addition, in the present example, a state in the game space may also be changed by performing at least one of arrangement, movement, and removal of a specific object different from the above terrain objects and decorative objects. At least one specific object is associated with each player character. Specific objects have the function of, when arranged in the game space, setting a reclamation region associated with a player character in the game space. It should be noted that specific objects may be an object that is previously arranged in the game space during the start of a game, an object that is arranged at a predetermined location when a predetermined acquisition condition is satisfied, e.g., the player level reaches a predetermined level or a mission is achieved, or an object that is arranged when the object is dropped by another character or another character is beaten, or is obtained from an object that is not different from specific objects. In addition, specific objects may be an object to which another object is altered when a particular action is performed on the another object. In addition, in the present example, specific objects can be arranged at any location in the game space. In another example, locations in the game space at which specific objects can be arranged may be limited.

A specific object is arranged in the game space by a player character PC associated with the specific object performing an arrangement action of placing or throwing the specific object according to a user's operation. In another example, a specific object may be arranged at a location in the game space with reference to the location of a player character PC without the player character PC performing the above arrangement action. In that case, a specific object carried or stored by a player character PC may be arranged at a location that is a predetermined distance away from the player character PC in the front direction of the player character PC according to a user's arrangement instruction operation input without the player character PC performing an action.

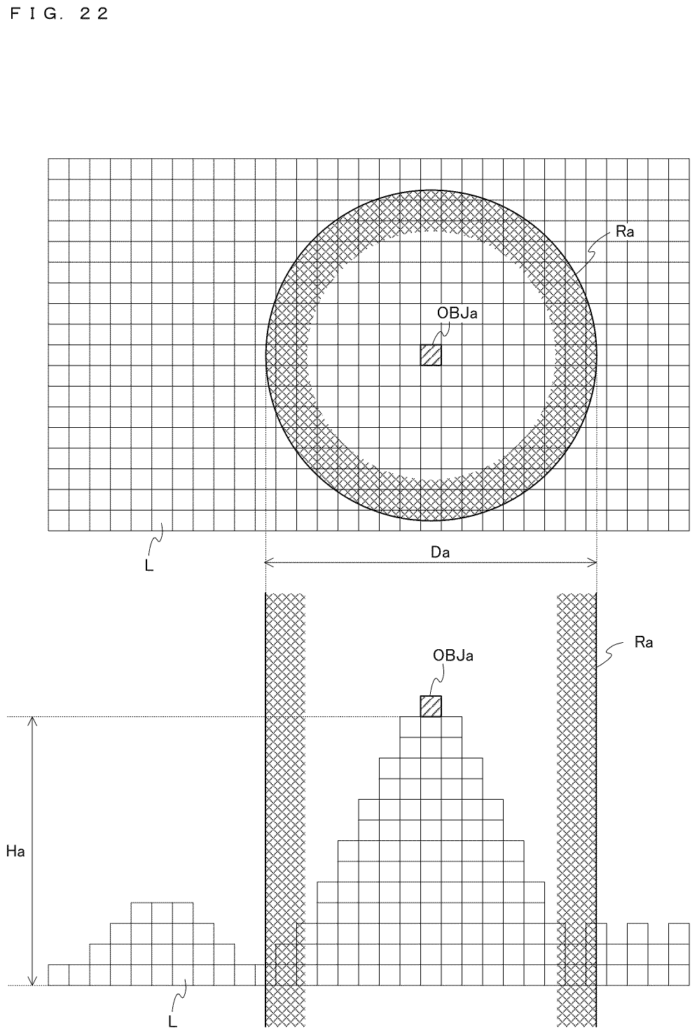

Next, an example of a location, shape, and size of a reclamation region Ra that is set when a specific object OBJa is arranged in the game space will be described with reference to FIG. 22.

As illustrated in FIG. 22, the reclamation region Ra is a cylindrical space that has a cylinder axis that is a vertical straight line in the game space passing through the location of the specific object OBJa arranged in the game space, and extends upper and lower height limits. In this case, the reclamation region Ra has a circular shape in the horizontal direction, and the specific object OBJa is arranged at the center of the circular shape, so that the specific object OBJa is included in the reclamation region Ra.

For example, the area in the horizontal direction of the reclamation region Ra increases as a height Ha in the game space at which the specific object OBJa is arranged increases. As an example, the area in the horizontal direction of the reclamation region Ra is proportional to the height Ha at which the specific object OBJa is arranged, and if in this case the area is lower than a predetermined value, the area is set to the predetermined value. For example, the reclamation region Ra has an area in the horizontal direction around the location of the specific object OBJa as the center thereof. In the case in which the reclamation region Ra is the above cylindrical space, as the height Ha in the game space at which the specific object OBJa is arranged increases, the radius (diameter Da) around the specific object OBJa as the center increases. It should be noted that the reclamation region Ra may have a shape different from the cylindrical shape that extends the height limits in the vertical direction of the game space. In addition, when a player character PC associated with the specific object OBJa moves the specific object OBJa in the game space, the reclamation region Ra that has once been set may be moved in association with the movement of the specific object OBJa. In addition, the method for setting a reclamation region based on the location where a specific object is arranged is not particularly limited. A reclamation region may be set such that the reclamation region has a constant size irrespective of the height at which a specific object is arranged.

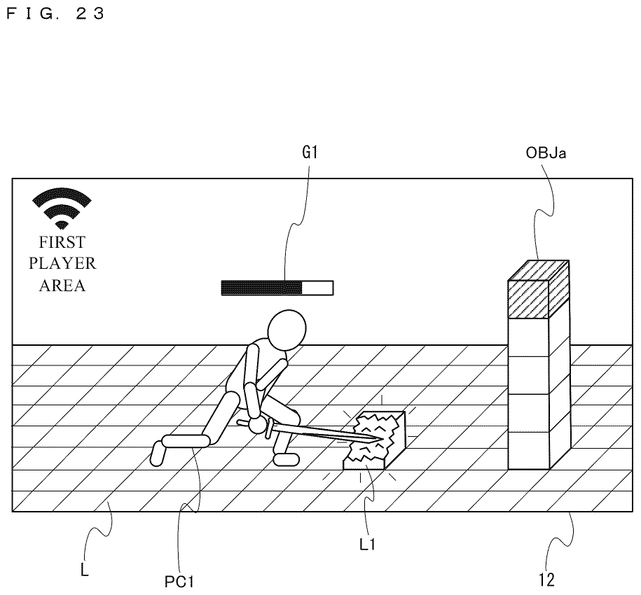

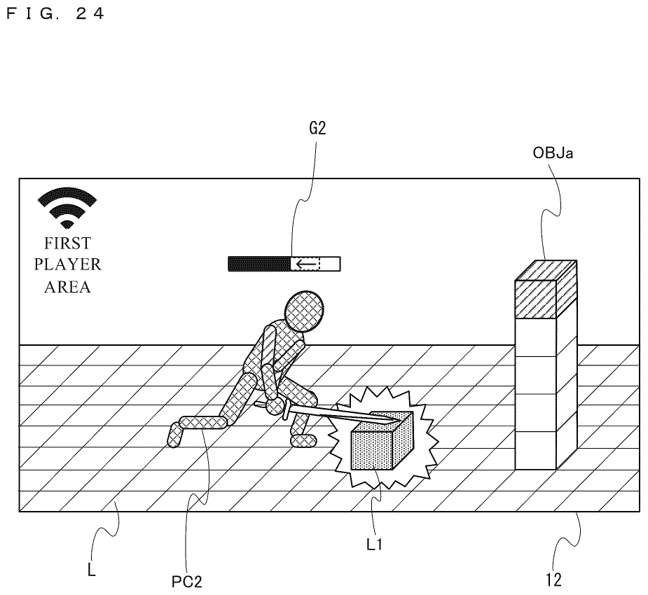

A function of the reclamation region Ra that is set when the specific object OBJa is arranged in the game space will be described with reference to FIGS. 23 and 24.

In the present example, a game space in the reclamation region Ra is set to a reclaimed state on a unit region by unit region basis. In the present example, the game field may be in one of an unreclaimed state and a reclaimed state on a unit region by unit region basis. In the initial state of a game, all unit regions in the game field may be in the unreclaimed state, and when a unit region is set to the reclaimed state, the display form of the game field may be changed in said unit region. As an example, in the reclamation region Ra, reclaimed unit regions may be caused to be brighter than unreclaimed unit regions so that the reclaimed unit regions can be distinguished from other regions. As a result, unreclaimed unit regions farther than a predetermined distance may not be viewed outside the reclamation region Ra, whereas reclaimed unit regions farther than a predetermined distance may be viewed inside the reclamation region Ra. As another example, an upper surface of the game field in unit regions in the unreclaimed state may be displayed as having an appearance representing a desert, and an upper surface of the game field in unit regions in the reclaimed state may be displayed as having an appearance representing a lawn. It should be noted that reclaimed unit regions and unreclaimed unit regions may or may not be displayed in a manner that allows both types of unit regions to be distinguished from each other. Thus, player characters PC can expand a reclaimed region by arranging a specific object on the game field. In addition, each user can check a location where an action for reclamation has been performed, by viewing a specific object arranged in the game space.

It should be noted that in the present example, unit regions that have been set to the reclaimed state are not returned to the unreclaimed state. For example, when a specific object is moved to another place, so that a unit region is out of a reclamation region, said unit region is not returned to the unreclaimed state. In another example, a unit region that has been set to the reclaimed state may be returned to the unreclaimed state under a certain condition. In addition, a player character PC's action for setting a unit region to the reclaimed state is not particularly limited, and is not limited to an action of arranging a specific object. For example, in another example, a unit region may be changed to the reclaimed state when a player character PC performs an action of using a predetermined item.

In the present example, action control is performed such that a predetermined actions has a form that varies depending on whether or not a player character PC that has set the reclamation region Ra is located in the reclamation region Ra. For example, when a player character PC that has set the reclamation region Ra is located in the reclamation region Ra, the player character PC is given a buffing effect. For example, when a player character PC given a buffing effect performs a predetermined action, the player character PC's predetermined action is controlled so as to be more advantageous than when the player character PC has not been given a buffing effect.

In the present example, in the reclamation region Ra, a change in the game space is limited, except for a change in the game space by an action of a player character PC that has set the reclamation region Ra. For example, in the reclamation region Ra, a change in the game space by player characters PC other than the player character PC that has set the reclamation region Ra is limited, and the right to edit in the reclamation region Ra is given to the player character PC that has set the reclamation region Ra.

For example, in a game image illustrated in FIG. 23, a first player character PC1 is arranged in a reclamation region Ra (first player area) formed by a specific object OBJa arranged by the first player character PC1. In addition, in the reclamation region Ra, the first player character PC1 is performing an action of destroying and removing a terrain object L1. In the reclamation region Ra, the first player character PC1 has been given the right to edit, and therefore, can destroy and remove the terrain object L1 by performing the above action. In addition, remaining energy that is a parameter associated with the first player character PC1 and is indicated by a gage G1 in FIG. 23 is reduced due to the above action when the first player character PC1 is located outside the reclamation region Ra, and a buffing effect of avoiding such a reduction caused by the above action is given to the first player character PC1 when the first player character PC1 is located in the reclamation region Ra. As another example, a buffing effect that is given to the first player character PC1 in the first region R1 allows the first player character PC1 to move at a speed higher than that in the normal state when moving in the reclamation region Ra.

Meanwhile, in a game image illustrated in FIG. 24, a second player character PC2 is arranged in a reclamation region Ra (first player area). In addition, in the reclamation region Ra, the second player character PC2 is performing an action of destroying and removing a terrain object L1. In the reclamation region Ra, the second player character PC2 is not given the right to edit, and therefore, cannot destroy or remove the terrain object L1 even if the second player character PC2 performs the above action. In addition, remaining energy that is a parameter associated with the second player character PC2 and is indicated by a gage G2 in FIG. 24 is reduced by a predetermined amount due to the above action because the second player character PC2 is not given a buffing effect in the reclamation region Ra. Since a buffing effect is not given to the second player character PC2 in the reclamation region Ra, when the second player character PC2 moves in the reclamation region Ra, the second player character PC2 moves at the speed of the normal state.

It should be noted that in another example, a plurality of types of specific objects may be prepared, and the function of a reclamation region based on a specific object may vary depending on the type of the specific object. For example, a buffing effect given in a reclamation region, the right to edit given in a reclamation region, a condition for a player character to which a buffing effect is given or for which editing is limited in a reclamation region, and the like may be configured to vary depending on the type of a specific object.

In the present example, the game field is divided into a plurality of sections. A section includes a plurality of unit regions. In the present example, the game field is not divided into a plurality of sections in the vertical direction. In another example, the game field may be divided into a plurality of sections in the vertical direction. In addition, sections have equal sizes (the size is represented by the number of unit regions included in a section) (e.g., each section includes 512×512 unit regions). In another example, different sections may have different sizes.

In the present example, when each player character reclaims the game field (i.e., a unit region in the unreclaimed state is changed to the reclaimed state), a section reclamation value is calculated. The section reclamation value is a parameter corresponding to the number of unit regions in the reclaimed state of unit regions included in a section. As an example, the section reclamation value is a parameter that is associated with each section, and that indicates the proportion of reclaimed unit regions in the section. For example, the section reclamation value is calculated, for each section, by dividing the number of reclaimed unit regions in the section by the total number of unit regions included in the section.

In the present example, for a section for which the section reclamation value satisfies a predetermined removal condition, a predetermined process is performed. The removal condition may be that the section reclamation value reaches a predetermined removal value, or that a predetermined proportion of unit regions in the section are in the reclaimed state. As a first example, when the section reclamation value satisfies the removal condition, each player character PC arranged in the section is allowed to move to one adjacent to said section. As a result, as a player character PC reclaims more and more, the user is allowed to move the player character PC to other sections. As a second example, when the section reclamation value satisfies the removal condition, the lightness of the game field in the section is maximized. For example, the game field in a section is displayed with a higher lightness as the section reclamation value in the section increases, and with the maximum lightness when the section reclamation value satisfies the removal condition. As a third example, in a section in which the section reclamation value satisfies the removal condition, all unit regions that are in the unreclaimed state are changed to the reclaimed state. In this case, in a section in which the section reclamation value satisfies the removal condition, all unit regions in the section are in the reclaimed state.

In the present example, for each player character, a section activity amount is calculated according to the player character's activity in a section. The section activity amount is a parameter that is associated with each section, and increases as the player character's activity increases in the section. As a first example, the section activity amount is calculated based on the number of times a player character PC has given first social points (high rating (“like”) or second social points to other player characters PC during a period of time from a predetermined time before to the current time (e.g., one day from 24 hours before to the current time) in the section. As a second example, the section activity amount is calculated based on the number of player characters PC existing in the section during a period of time from a predetermined time before to the current time. For example, in the second example, the section activity amount may be calculated based on the number of player characters PC existing in the section at the current time, the average, greatest value, increase, or the like of the number of player characters PC that have existed during a period of time from a predetermined time before to the current time, or the like. As a third example, the section activity amount is calculated based on a total movement distance over which a player character PC has moved in the section during a period of time from a predetermined time before to the current time. As a fourth example, the section activity amount is calculated based on the number of objects (terrain objects, decorative objects) that have been generated, edited, and duplicated in the section during a period of time from a predetermined time before to the current time. It should be noted that the section activity amount may be calculated by combining (e.g., adding up) at least two of the values calculated in the first to fourth examples. In the case in which the section activity amount is calculated by combining the values calculated in the first to fourth examples, one or more of the values may be weighted (e.g., multiplied by a coefficient greater than one) under a predetermined condition. In addition, a section to which the section activity amount is to be assigned may be selected based on the location of a player character that has performed an action. Alternatively, a section to which the section activity amount is to be assigned may be selected based on the location of a target on which the action has been performed (an object that has been generated, edited, duplicated, or the like by another player character PC, another player character itself, or the like).

In the present example, a section information image showing the section activity amount and the section reclamation value for each section can be displayed. For example, in the present example, when a user performs an operation instruction input for displaying the section information image, a map image with which information about the section activity amount and the section reclamation value at that time can be viewed for each section is displayed.

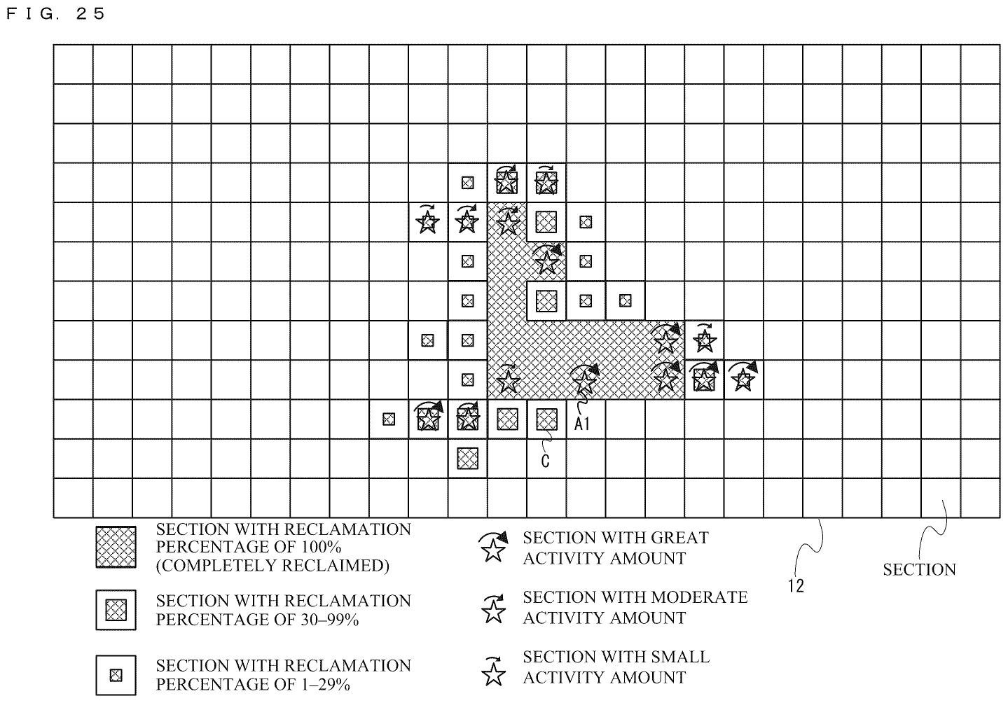

FIG. 25 illustrates an example section information image displayed on the display 12. In FIG. 25, the example section information image is displayed in the form of a map obtained when the game field included in a predetermined range is viewed from above in the game space. The section information image shows sections of the game field arranged in a grid pattern in the horizontal direction. In each section, an image indicating the level of the section activity amount in the section and an image indicating the level of the section reclamation value are displayed.

For example, the section activity amount has a plurality of levels between the maximum and minimum values thereof calculated for each section, and the level of the section activity amount in each section is represented by a first activity amount object that is displayed in a display form that varies depending on the level. As a first example, the level of the section activity amount in each section is represented by the speed of the rotation of the first activity amount object (in FIG. 25, a star-shaped object A1 is illustrated). Specifically, the first activity amount object whose rotational speed increases as the level of the section activity amount increases (in FIG. 25, the rotational speed of the star-shaped object is represented by the size of an arrow as an example) is displayed in each section of the section information image. As a second example, the level in each section is represented by the speed of the movement of the first activity amount object. Specifically, the first activity amount object that moves on a predetermined orbit in each section at a higher movement speed as the level of the section activity amount increases is displayed in the section information image. As a third example, when the section activity amount is greater than that those of surrounding sections, this is represented by the rotational speed or movement speed of the first activity amount object that is higher than those of the surrounding sections. It should be noted that in all of these examples, the first activity amount object may not be displayed in sections in which the section activity amount is zero (i.e., sections in which the section activity amount has the minimum value). In another example, in all of these examples, the motion of the first activity amount object may be stopped in sections in which the section activity amount is zero.

In addition, the proportion indicating the section reclamation value calculated in each section has a plurality of levels, and the level of the section reclamation value in each section is represented by a number-of-unit-regions object that is displayed in a form that varies depending on the level. As an example, the level of the section reclamation value in each section is represented by the size in the horizontal direction of the number-of-unit-regions object (in FIG. 25, a cross-hatched object C is illustrated). Specifically, the number-of-unit-regions object that is more enlarged in the horizontal direction as the level of the proportion indicating the section reclamation value increases is displayed in each section of the section information image. It should be noted that the number-of-unit-regions object may not be displayed in sections whose section reclamation value is 0%.

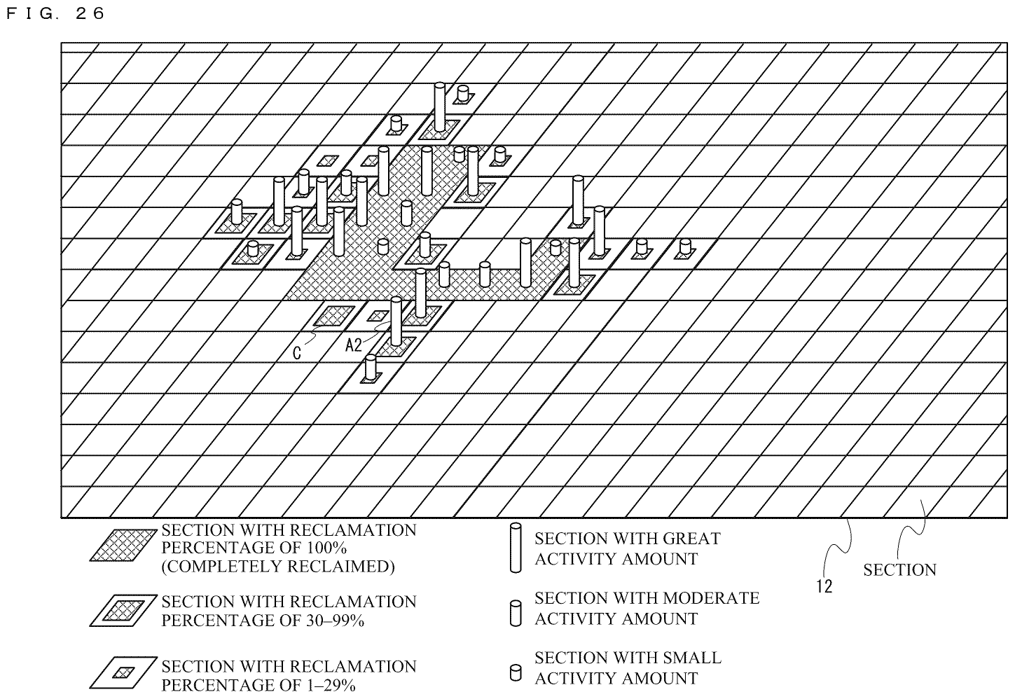

FIG. 26 illustrates another example of the section information image displayed on the display 12. In FIG. 26, this example of the section information image is displayed in the form of a map obtained when the game field included in a predetermined range is viewed from above in the game space. Also in this example of the section information image, the section information image shows sections of the game field arranged in a grid pattern in the horizontal direction. In each section, an image indicating the level of the section activity amount in the section and an image indicating the level of the section reclamation value are displayed.

The section activity amount has a plurality of levels between the maximum and minimum values thereof calculated for each section, and the level of the section activity amount in each section is represented by a second activity amount object that is displayed in a display form that varies depending on the level. As an example, the level of the section activity amount in each section is represented by the length of elongation of the second activity amount object (in FIG. 26, a columnar object A2 is illustrated). Specifically, the second activity amount object that repeatedly extends and contracts in the vertical direction of the game field in the section information image, and the maximum size of the elongation increases as the level of the section activity amount increases, is displayed in each section of the section information image. It should be noted that the second activity amount object may not be displayed in sections in which the section activity amount is zero (i.e., sections in which the section activity amount has the minimum value).

The section reclamation value displayed in another example of the section information image is similar to that of the above example of the section information image, except for the display direction, and therefore, will not be described in detail.

Thus, the section information image can show both information about the section activity amount and information about the section reclamation value for each section, and therefore, a section in which there is a high activity between users can be found, and the reason for the high activity can be inferred. For example, in addition, for a section in which the level of the section reclamation value is relatively low and the level of the section activity amount is relatively high, it can be inferred that a user is frequently reclaiming the game field in that section. For a section in which both the level of the section reclamation value and the level of the section activity amount are relatively high, it can be inferred that a social activity between users is frequently performed in that section.

It should be noted that as an example, in the above section information image, a section in which a player character PC operated by a user who has performed an operation instruction input of displaying the section information image is arranged may be displayed in a manner that can distinguish that section from other sections. As another example, in the above section information image, a display range of the game field may be displayed in which sections around a section in which a player character PC operated by a user who has performed an operation instruction input of displaying the section information image is arranged can be viewed.

In addition, the horizontal direction in the above section information image may be a direction along a sphere. For example, in the case in which the entire game field is configured in the form of a spherical celestial body, the horizontal direction in the section information image is along a sphere corresponding to the shape of the celestial body. In this case, sections arranged in a grid pattern in the section information image are displayed and arranged in a grid pattern in a direction along the above sphere. In addition, the activity amount object and the number-of-unit-regions object are each displayed with reference to the horizontal direction and the vertical direction in each section.

In addition, in the present example, the section information image may show one of information about the section activity amount and information about the section reclamation value, and may further display other information for each section. In addition, at least one piece of information used for displaying the section information image (information about the section activity amount and/or information about the section reclamation value) may be obtained from the server 102 before being displayed, or at least one piece of information regularly obtained by the main body apparatus 2 from the server 102 may be used.

In addition, the virtual space for generating the section information image may be generated separately from the game space in which a game is proceeded based on a player character PC's action, or the virtual and game spaces may be the same space. In the former case, the section information image and the game image may be generated by switching between a virtual camera that is arranged in the virtual space in order to generate the section information image and a virtual camera that is arranged in the game space in order to cause a game to proceed, according to a user's operation input. In the latter case, the section information image may be generated by arranging the activity amount object and the number-of-unit-regions object in each section in the game space in which a game is proceeded, according to a user's operation instruction input of displaying the section information image. In either of the cases, the image to be displayed may be selected according to the switching while both the section information image and the game image may be always generated/updated. In addition, a state of the game space in which a game is proceeded according to a player character PC's action and a state of the virtual space for generating the section information image may be simultaneously generated and displayed. As an example, a state of the virtual space for generating the section information image may be displayed in the display form of a mini-map, overlaying an image showing the game space.

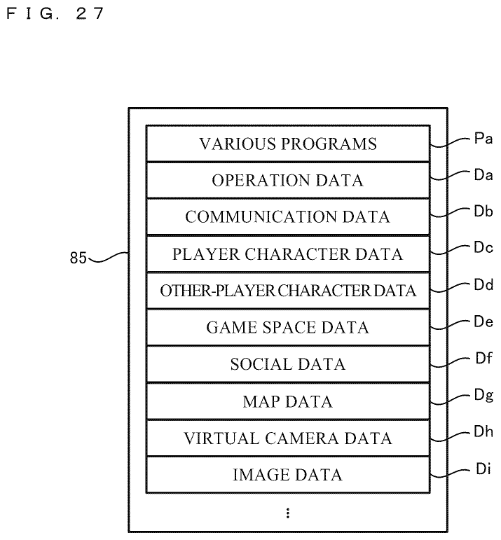

Next, an example of a specific process that is executed in the game system 1 will be described with reference to FIG. 27. It should be noted that in addition to the data of FIG. 27, the DRAM 85 also stores data used in other processes, which will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, a communication program for communicating with other apparatuses (the server 102 and other game systems 1), and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, communication data Db, player character data Dc, other-player character data Dd, game space data De, social data Df, map data Dg, virtual camera data Dh, image data Di, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The communication data Db includes transmission data to be transmitted to other apparatuses (the server 102 and other game systems 1) and reception data received from other apparatuses. For example, the transmission data includes information about the action, state, and the like of a player character PC operated by the user of the game system 1, information about social points (first social points, second social points), information about a game space changed by the player character PC's action, and the like. In addition, the reception data includes information about the actions, states, and the like of other player characters PC operated by the users of other game systems 1, information for displaying the section information image (map image), information about social points, information about a game space changed by the other player characters PC, and the like.

The player character data Dc indicates parameters such as the position, direction, pose, action, state, ability, remaining energy, and the like in a game space of a player character operated by the user of the game system 1 (hereinafter referred to as a first player character PC1), and the like. The other-player character data Dd indicates parameters such as the positions, directions, poses, actions, states, abilities, remaining energies, and the like in a game space of other player characters operated by the users of other game systems 1 (hereinafter referred to as a second player character PC2), and the like.

The game space data De indicates the state of a game space. For example, the game space data De indicates a parameter related to the state of a terrain object, and a parameter related to the state of an decorative object for each coordinate point set in a game space, i.e., a parameter indicating whether or not an object (a terrain object, decorative object, specific object, or the like) exists at each of a plurality of coordinate points, and parameters indicating the type, state (states related to a creator, an editor, and social points), and the like of an existing object. The game space data De also stores data indicating the location of a reclamation region set in the game space and a state (the reclaimed or unreclaimed state) of each unit region in the game space.

The social data Df is related to social points given to a player character (the first player character PC1) operated by a user of the game system 1 (can also be said to be social points given to a user of the game system 1), and social points given to other player characters.

The map data Dg indicates information about the section activity amount and information about the section reclamation value for each section, which is used in order to display the section information image.

The virtual camera data Dh indicates the position, direction, angle of view, and the like of a virtual camera arranged in a game space.

The image data Di is for displaying images (e.g., an image of each player character PC, an image of each object, a map image, and a background image) on a display screen (e.g., the display 12 of the main body apparatus 2).

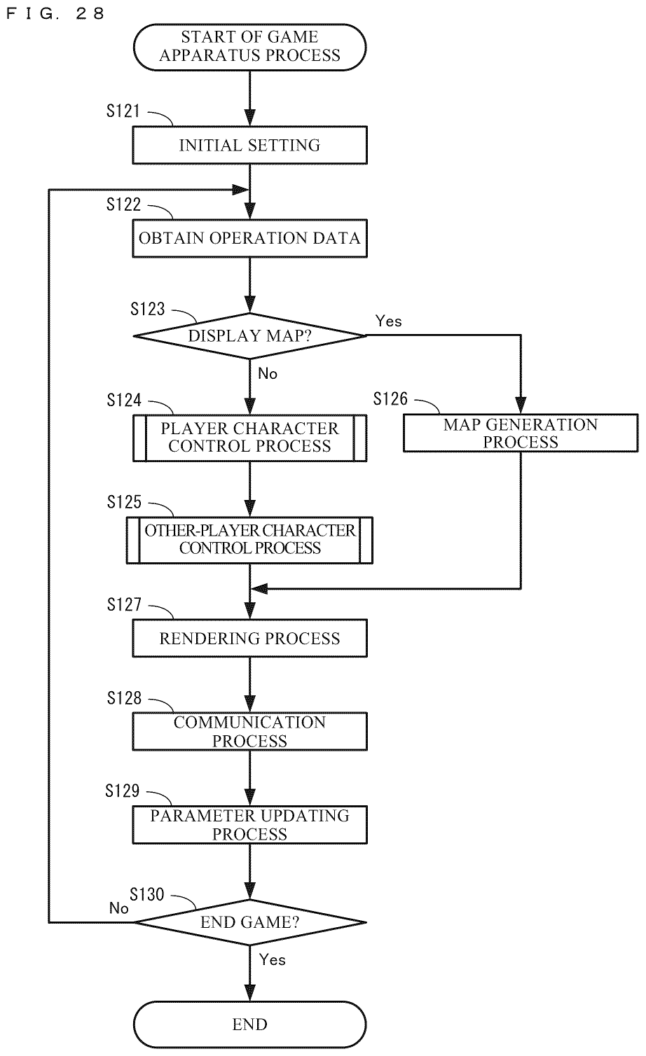

Next, a detailed example of a game process that is an example of an information process in the present example will be described with reference to FIGS. 28 to 31. In the present example, a series of steps illustrated in FIGS. 28 to 31 is executed by the processor 81 executing a predetermined application program (game program), a communication program, and the like included the programs Pa. The game process of FIGS. 28 to 31 is started with any appropriate timing.

It should be noted that the steps in the flowcharts of FIGS. 28 to 31, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., the server 102 and other game systems 1 that can communicate with the main body apparatus 2 via a network). Specifically, the steps of FIGS. 28 to 31 may be executed by a plurality of information processing apparatuses including the main body apparatus 2 cooperating with each other.

In FIG. 28, the processor 81 executes initial setting for the game process (step S121), and proceeds to the next step. For example, in the initial setting, the processor 81 initializes parameters for executing processes described below, and updates each data. As an example, in the case in which it is necessary to log in on the server 102 in order to start a game in which a plurality of users participate, the processor 81 performs a log-in process on the server 102 according to a log-in operation indicated by the operation data Da. The processor 81 obtains data related to a game space that has been allocated to the user by the log-in process, and produces a game space based on the data. Thereafter, the processor 81 arranges a first player character PC1, a virtual camera, and the like in a predetermined pose or orientation at a default position in the game space, and updates the player character data Dc, the game space data De, and the virtual camera data Dh. In addition, the processor 81 sets a reclamation region based on the location of a specific object associated with the first player character PC1 in the game space according to a situation of the specific object (e.g., when a game is started from the beginning, the specific object is arranged at a default position, and when a game is resumed from the middle, or a situation before a pause in a game is set based on data obtained in the log-in process and the like), and sets the game space data De. The processor 81, when a game is resumed from the middle, also obtains data related to social points acquired during a pause in the game from the server 102 by the log-in process, and updates the social data Df.

Next, the processor 81 obtains operation data from the left controller 3, the right controller 4, and/or the main body apparatus 2, updates the operation data Da (step S122), and proceeds to the next step.

Next, the processor 81 determines whether or not to display a map (step S123). For example, if the processor 81 determines with reference to the operation data Da that a user's operation instruction input of displaying a map has been performed, the result of the determination in step S123 is positive. If the processor 81 does not determine to display a map, the processor 81 proceeds to step S124. Otherwise, i.e., if the processor 81 determines to display a map, the processor proceeds to step S126.

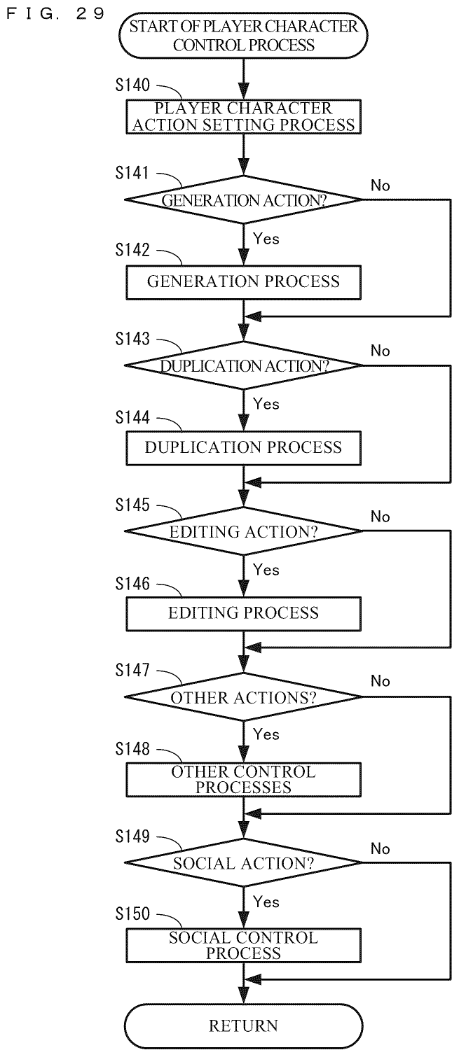

In step S124, the processor 81 performs a player character control process, and proceeds to step S125. The player character control process in step S124 will be described below with reference to FIG. 29.

In FIG. 28, the processor 81 executes a process of setting the first player character PC1's action (step S140), and proceeds to the next step. For example, the processor 81 sets the position, direction, pose, action, state, and the like of the first player character PC1 based on an operation input indicated by the operation data Da, virtual physical calculation in the game space (e.g., virtual inertia and force of gravity), and the like, and updates the player character data Dc.

Next, the processor 81 determines whether or not the first player character PC1's action of generating an object (a terrain object, decorative object, specific object, etc.) has been set (step S141). If the first player character PC1's action of generating an object has been set, the processor 81 proceeds to step S142. Otherwise, i.e., if the first player character PC1's action of generating an object has not been set, the processor 81 proceeds to step S143.

In step S142, the processor 81 executes a process of generating an object in the game space, and proceeds to step S143. For example, based on the first player character PC1's action that has been set, the processor 81 newly generates an object (a terrain object, decorative object, specific object, etc.) in the game space at a coordinate point where the object is to be generated, updates a parameter of the object according to the generation, and updates the game space data De. In addition, the processor 81 sets the creator and the editor of the generated object to the first player character PC1, and updates the game space data De. In addition, in step S142, if a specific object is generated in the game space, the processor 81 sets a reclamation region based on the location of the specific object newly arranged, changes unit regions in the reclamation region to the reclaimed state, and updates the game space data De.

In step S143, the processor 81 determines whether or not the first player character PC1's action of duplicating an object has been set. If the first player character PC1's action of duplicating an object has been set, the processor 81 proceeds to step S144. Otherwise, i.e., if the first player character PC1's action of duplicating an object has not been set, the processor 81 proceeds to step S145.

In step S144, the processor 81 executes a process of duplicating an object in the game space, and proceeds to step S145. For example, based on the first player character PC1's action that has been set, the processor 81 newly arranges an object at a coordinate point where the object is to be duplicated in the game space, updates a parameter of the object according to the duplication, and updates the game space data De. In addition, the processor 81 sets the creator of the duplicated object to the creator of the original object, sets the editor of the duplicated object to the first player character PC1, and updates the game space data De.

In step S145, the processor 81 determines whether or not the first player character PC1's action of editing an object has been set. If the first player character PC1's action of editing an object has been set, the processor 81 proceeds to step S146. Otherwise, i.e., if the first player character PC1's action of editing an object has not been set, the processor 81 proceeds to step S147.

In step S146, the processor 81 executes a process of editing an object to be edited, and proceeds to step S147. For example, the processor 81 edits an object on which the first player character PC1's action that has been set is to be performed, based on the action, updates a parameter of the object according to the editing, and updates the game space data De. In addition, the processor 81 sets the editor of the edited object to the first player character PC1, and updates the game space data De. In addition, if the editing has been performed so as to move a specific object in the game space, the processor 81 sets a reclamation region based on the location of the specific object after the movement, changes unit regions in the reclamation region to the reclaimed state, and updates the game space data De.

In step S147, the processor 81 determines whether or not the first player character PC1's action that has been set is another action. If the first player character PC1's action that has been set is another action, the processor 81 proceeds to step S148. Otherwise, i.e., if the first player character PC1's action that has been set is not another action, the processor 81 proceeds to step S149.

In step S148, the processor 81 executes another control process, and proceeds to step S149. As an example, if the processor 81 determines with reference to the operation data Da that an operation instruction to display and move the aiming point T has been performed, the processor 81 moves the position of the aiming point T according to the operation instruction, and sets and displays the creator and the editor of an object with which the aiming point T is aligned.

In step S149, the processor 81 determines whether or not an action associated with a social activity with another player character PC has been set. For example, if the first player character PC1's action that has been set in step S141 to S148 is to give the player character PC first social points or second social points, or if the operation data Da indicates a user's operation input of giving first social points or second social points, the result of the determination in step S149 is positive. If the social action has been set, the processor 81 proceeds to step S150. Otherwise, i.e., if the social action has not been set, the processor 81 ends the subroutine.

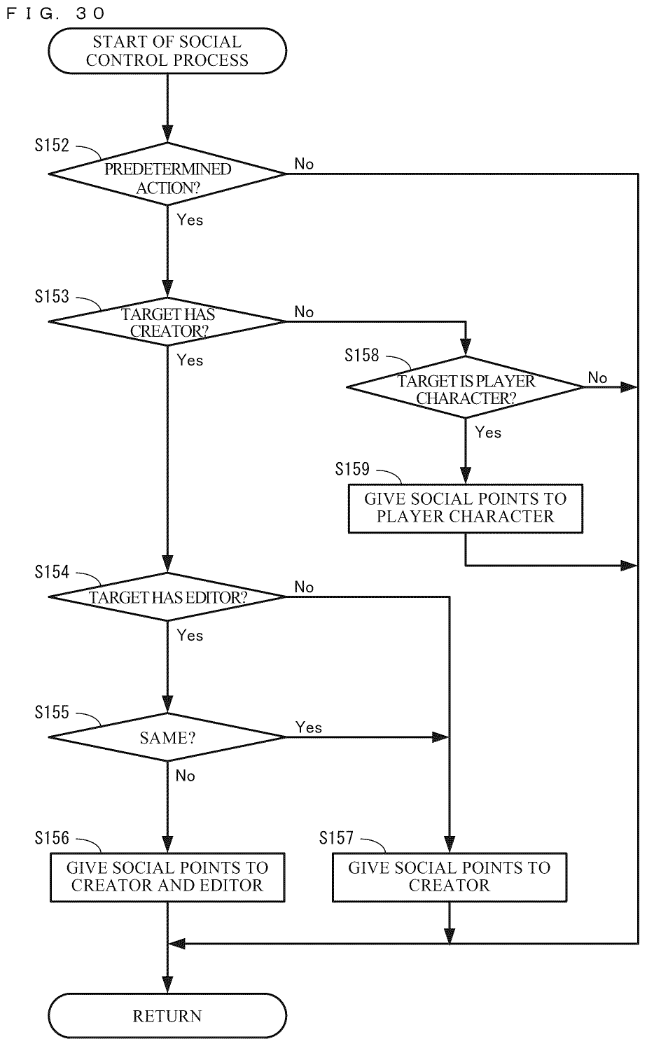

In step S150, the processor 81 executes a social control process, and ends the subroutine. The social control process in step S150 will be described below with reference to FIG. 30.

In FIG. 30, the processor 81 determines whether or not a predetermined action of giving another player character PC social points (first social points, second social points) has been set (step S152). If a predetermined action of giving another player character PC social points has been set, the processor 81 proceeds to step S153. Otherwise, i.e., if a predetermined action of giving another player character PC social points has not been set, the processor 81 ends the subroutine.

In step S153, the processor 81 determines whether or not the creator of an object on which the predetermined action is to be performed has been recorded. If the creator of the object has been recorded, the processor 81 proceeds to step S154. Otherwise, i.e., if the creator of the object has not been recorded or if the creator of the object is a player character PC, the processor 81 proceeds to step S158.

In step S154, the processor 81 determines whether or not the editor of an object on which the predetermined action is to be performed has been recorded. If the editor of the object has been recorded, the processor 81 proceeds to step S155. Otherwise, i.e., if the editor of the object has not been recorded, the processor 81 proceeds to step S157.

In step S154, the processor 81 determines whether or not the creator and the editor of an object on which the predetermined action is to be performed are the same. If the creator and the editor are not the same, the processor 81 proceeds to step S156. Otherwise, i.e., if the creator and the editor are the same, the processor 81 proceeds to step S157.

In step S156, the processor 81 sets the first player character PC1's action based on the predetermined action, updates the player character data Dc, selects the type of social points (first social points or second social points) to be given based on the action, sets the recorded creator and editor of an object on which the predetermined action is to be performed as a party to be given the selected social points, stores data indicating that a predetermined number of the selected social points are to be given to the party into the social data Df, and ends the subroutine.

Meanwhile, in step S157, the processor 81 sets the first player character PC1's action based on the predetermined action, updates the player character data Dc, selects the type of social points (first social points or second social points) to be given based on the action, sets the recorded creator of an object on which the predetermined action is to be performed as a party to be given the selected social points, stores data indicating that a predetermined number of the selected social points are to be given to the party into the social data Df, and ends the subroutine.

If the result of the determination in step S153 is negative, the processor 81 determines whether or not the target of the predetermined action is another player character PC. If the target is another player character PC, the processor 81 proceeds to step S159. Otherwise, i.e., if the target is not another player character PC, the processor 81 ends the subroutine.

In step S159, the processor 81 sets the first player character PC1's action based on the predetermined action, updates the player character data Dc, sets another player character PC itself on which the predetermined action is to be performed as a party to be given first social points, stores data indicating that a predetermined number of first social points are to be given to the party into the social data Df, and ends the subroutine.

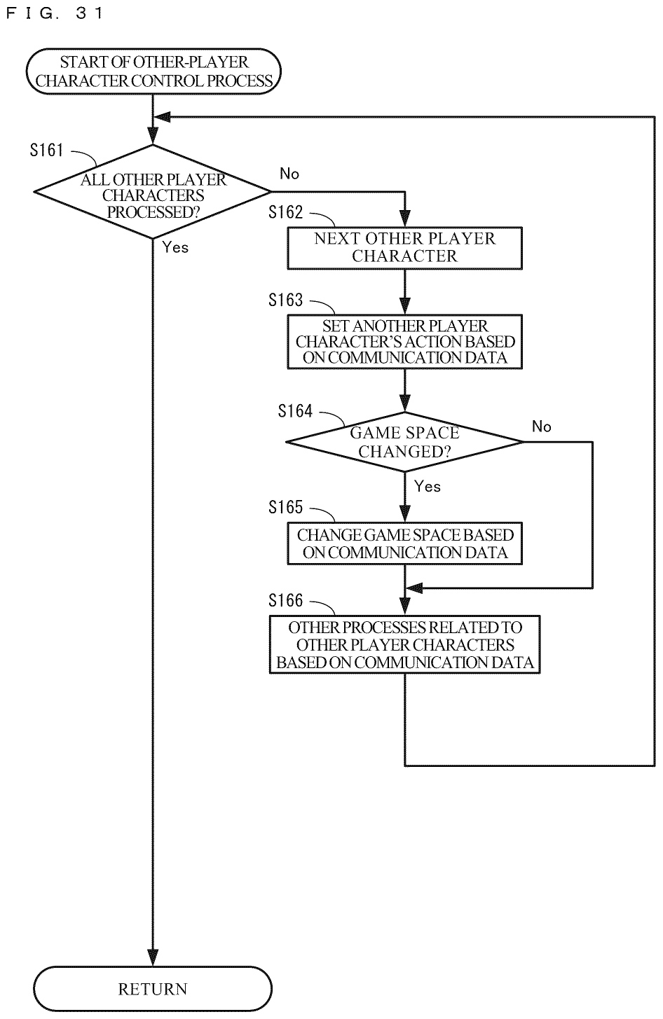

Referring back to FIG. 28, in step S125, the processor 81 executes an other-player character control process, and proceeds to step S127. The other-player character control process in step S125 will be described below with reference to FIG. 31.

In FIG. 31, the processor 81 determines whether or not all of steps S162 to S166 have been completed for all other player characters PC arranged in the game space (step S161). If steps S162 to S166 have not been completed for all other player characters PC, the processor 81 proceeds to step S162. Otherwise, i.e., if steps S162 to S166 have been completed for all other player characters PC, the processor 81 ends the subroutine.

In step S162, the processor 81 chooses a player character PC for which steps S162 to S166 have not been completed, of all other player characters PC arranged in the game space, and proceeds to the next step.

Next, the processor 81 sets an action of another player character PC that is to be processed, based on the communication data Db (step S163), and proceeds to the next step. For example, the processor 81 retrieves, from the communication data Db, information about another player character PC to be processed that is received from the game system 1 of another user who is operating the another player character PC, sets the another player character PC's action based on said information, and updates the other-player character data Dd. It should be noted that, in the game system 1 of the another user, processes including step S124 are performed on the player character PC operated by the another user, and said game system 1 transmits communication data generated according to the result of the processes. Thereafter, in step S128 described below, data transmitted from the game system 1 of another user is received and stored into the communication data Db as appropriate, and in step S163 or steps S164 to S166 described below, the data thus stored in the communication data Db is used.

Next, the processor 81 determines, based on the communication data Db, whether or not the game space has been changed by an action of another player character PC to be processed (step S164). For example, the processor 81 determines whether or not the game space has been changed by another player character PC to be processed, based on information about the game space received from the game system 1 of the another user operating the another player character PC. If the game space has been changed by the another user operating the another player character PC to be processed, the processor 81 proceeds to step S165. Otherwise, i.e., if the game space has not been changed by the another user operating the another player character PC to be processed, the processor 81 proceeds to step S166.

In step S165, the processor 81 performs a process of changing the game space based on an action of the another player character PC to be processed, based on the communication data Db, and proceeds to step S166. For example, the processor 81 retrieves, from the communication data Db, information about the game space changed by the action of another player character PC to be processed that has been received from the game system 1 of another user operating the another player character PC. Thereafter, based on the information, the processor 81 updates a parameter at a coordinate point in the game space related to an object generated, edited, or duplicated by the action of the another player character PC to be processed, to update the game space data De. In addition, if a specific object has been moved or arranged in the game space by another player character PC's action to be processed, the processor 81 sets a reclamation region based on the location of the specific object, changes unit regions in the reclamation region to the reclaimed state, and updates the game space data De.

In step S166, the processor 81 executes other processes related to other player characters PC to be processed, and returns to and repeats step S161.

Referring back to FIG. 28, if in step S123 the processor 81 determines to display a map, the processor 81 executes a map generation process (step S126), and proceeds to step S127. For example, the processor 81 sets, into the communication data Db, transmission data for requesting the server 102 to transmit map data for displaying a map image. Thereafter, the processor 81 looks up the map data Dg to retrieve information for displaying a map received from the server 102, and based on the information, sets a virtual space for generating the section information image (a map image; see FIGS. 25 and 26).

In step S127, the processor 81 executes a rendering process, and proceeds to the next step. In the present example, the processor 81 performs control to display, on the display 12, an image of the game space or a map image based on the results of the processes in steps S124 and S125. As an example, based on the results of the above processes and the game space data De, the processor 81 sets a game space including objects, a reclamation region, an aiming point, character information, and the like. In addition, the processor 81 arranges and causes each player character PC to perform an action in the game space based on the player character data Dc and the other-player character data Dd. In addition, the processor 81 sets the position and/or orientation of a virtual camera for producing a display image based on the virtual camera data Dh to arrange the virtual camera in the game space. Thereafter, the processor 81 generates an image of the game space as viewed from the virtual camera thus set, and controls the display 12 so that the game space image is displayed on the display 12. It should be noted that the processor 81 may execute a process of controlling the movement of the virtual camera in the game space based on the position and pose of the first player character PC1, and update the virtual camera data Dh. As another example, the processor 81 performs control to arrange a virtual camera in the virtual space for generating a map image set in step S126, update the virtual camera data Dh, generates a map image of the virtual space as viewed from the virtual camera, and display the map image on the display 12. It should be noted that in any of the examples, the processor 81 may move the virtual camera in the game space based on the operation data Da, and update the virtual camera data Dh.

Next, the processor 81 performs a communication process (step S128), and proceeds to the next step. For example, the processor 81 prepares transmission data to be transmitted to the server 102, stores the transmission data into the communication data Db, and transmits the transmission data to the server 102. The processor 81 also stores received data received from the server 102 into the communication data Db. As an example, the processor 81 prepares information related to the action, state, and the like of a player character PC operated by the user (the first player character PC1) based on the player character data Dc, and stores the information as a portion of the transmission data into the communication data Db. In addition, the processor 81 prepares, based on the game space data De, information related to an object generated, edited, or duplicated by a player character PC operated by a user, and information related to a reclamation region associated with the player character PC operated by the user, as information related to the game space changed by the player character PC's action, and stores the prepared information as a portion of the transmission data into the communication data Db. In addition, the processor 81 stores data indicating that social points are to be given to another player character, as a portion of the transmission data, into the communication data Db, based on data for giving social points to another player character, which is stored in the social data Df.

Next, the processor 81 executes a parameter updating process (step S129), and proceeds to the next step. As an example, the processor 81 adds newly given social points (first social points, second social points) to a player character PC operated by a user (the first player character PC1) based on the social data obtained from the server 102 in step S128, and updates the social data Df. As another example, if the processor 81 determines that the operation data Da indicates the user's operation input with which social points are consumed, the processor 81 increases the player character PC's ability by increasing the player level according to the operation input, consumes social points, and updates the player character data Dc and the social data Df.

Next, the processor 81 determines whether or not to end the game process (step S130). In step S130, the game process is ended, for example, if a condition for ending the game process is satisfied, the user has performed an operation of ending the game process, the user has performed an operation of logging off, or the like. If the processor 81 determines not to end the game process, the processor 81 returns to and repeats step S122. Otherwise, i.e., if the processor 81 determines to end the game process, the processor 81 transmits data indicating ending (log-off) of the game to the server 102, and ends the flowchart. Following this, steps S122 to S130 are repeatedly executed until the processor 81 determines to end the game process in step S130.

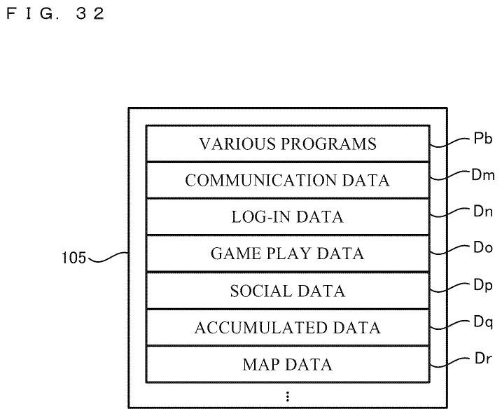

Next, data and a program stored in the storage unit 105 of the server 102 will be described with reference to FIG. 32. It should be noted that the server 102 also stores, in addition to the data illustrated in FIG. 32, data used in other processes, which will not be described in detail.

As illustrated in FIG. 32, the storage unit 105 stores, in a data storage area, communication data Dm, log-in data Dn, game play data Do, social data Dp, accumulated data Dq, map data Dr, and the like. The storage unit 105 also stores, in a program storage area, various programs Pb for implementing the above processes.

The communication data Dm includes received data received from each of game systems 1, and transmission data to be transmitted to each of game systems 1.

The log-in data Dn is used in a log-in process for each of the users of game systems 1. The log-in data Dn includes the ID, password, log-in/log-off state, log-in history, a game space in which a logged-in user is permitted to participate, and the like of each user, which are checked in the log-in process.

The game play data Do includes data related to a player character PC received from each game system 1, data related to an object and reclamation region in a game space received from each game system 1, a state of each game space, and a state of the player character PC.

The social data Dp is management data in which social points (first social points, second social points) possessed by each user (i.e., a player character PC operated by the user) are accumulated.

The accumulated data Dq is data in which social points (first social points, second social points) given to a user not logged-in are temporarily accumulated.

The map data Dr is for generating a section information image for each game space, and indicates a section activity amount and section reclamation value for each section in the game space.

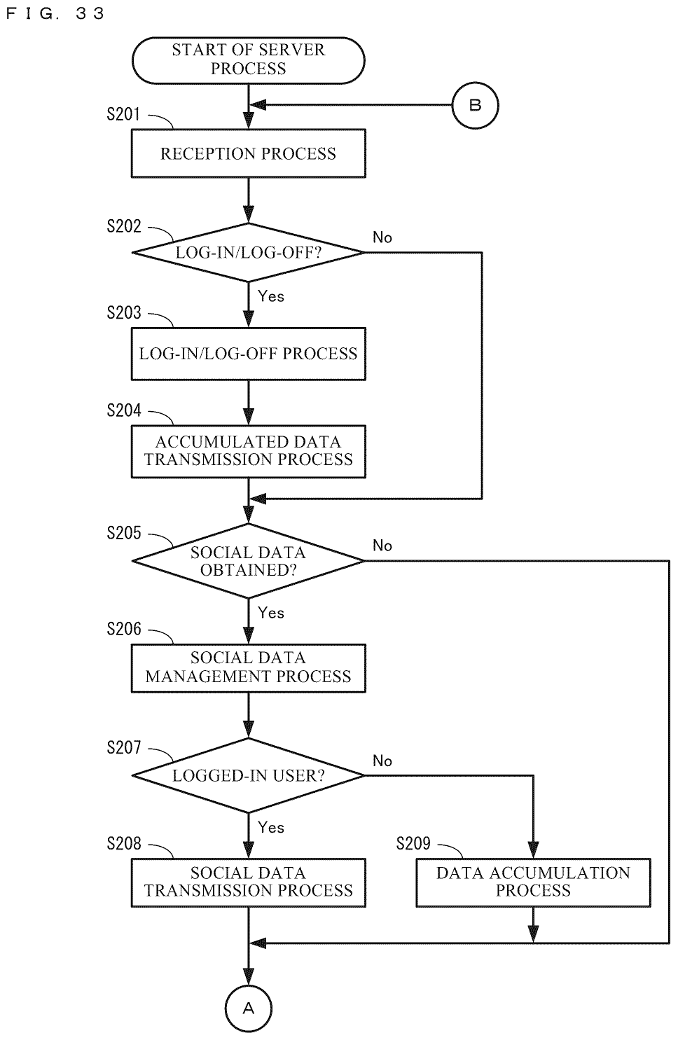

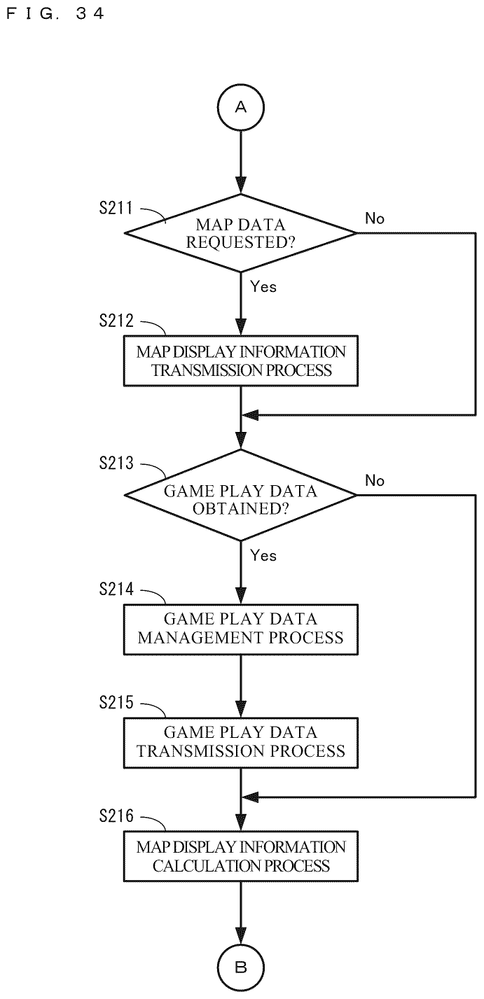

Next, processes that are executed in the server 102 will be described below with reference to FIGS. 33 and 34. Here, in the flowcharts of FIGS. 33 and 34, of the processes of the information processing system 100, the above game process in which a game space is shared by player characters PC operated by a plurality of users who play a game will be mainly described, and other processes that are not directly involved with those processes will not be described in detail. In FIGS. 33 and 34, each step that is executed by the control unit 104 is abbreviated to ‘S’.

It should be noted that the steps in the flowcharts of FIGS. 33 and 34, which are merely illustrative, may be executed in a different order, or another step may be executed in addition to and/or instead of each step, as long as a similar effect is obtained. In the present example, it is assumed that the control unit 104 (CPU) executes each step of the flowcharts. Alternatively, a portion of the steps of the flowcharts may be executed by the control unit 104 (CPU), and the other portions may be executed by a processor or dedicated circuit other than the control unit 104 (CPU). In addition, all the steps of the flowcharts may be executed by a processor or dedicated circuit other than the control unit 104 (CPU).

In FIG. 33, the control unit 104 of the server 102 executes a process of receiving transmission data transmitted from each game system 1, and storing the transmission data into the communication data Dm (step S201), and proceeds to the next step.

Next, the control unit 104 determines whether or not the data received in step S201 indicates a log-in/log-off operation (step S202). If the data is log-in data or log-off data, the control unit 104 proceeds to step S203. Otherwise, i.e., if the data is neither log-in data nor log-off data, the control unit 104 proceeds to step S205.

In step S203, the control unit 104 executes a log-in/log-off process, and proceeds to the next step. As an example, the control unit 104 determines whether or not to permit a user of a game system 1 that has transmitted log-in data to log in. If the control unit 104 determines to permit a user of a game system 1 that has transmitted log-in data to log in, the control unit 104 sets the user into a logged-in state, and updates the log-in data Dn. Thereafter, the control unit 104 looks up the log-in data Dn and the game play data Do, selects a game space in which the user who has transmitted the log-in data is to participate, sets transmission data that indicates, to the user, log-in permission, a game space in which the user is permitted to participate, and information about the game space, into the communication data Dm, and transmits log-in data to the game system 1 of the user. As another example, the control unit sets a user of a game system 1 who has transmitted log-off data to a logged-off state, and updates the log-in data Dn. Thereafter, the control unit 104 sets, into the communication data Dm, transmission data indicating that a player character PC operated by the logged-off user is to be caused to disappear from the game space, and transmits the communication data Dm to game systems 1 of users which are involved with the game space in which said user has participated.

Next, the control unit 104 executes a process of transmitting data indicating social points accumulated for a user that has been permitted to log in (step S204), and proceeds to step S205. For example, if social points given to a user permitted to log in have been accumulated in the accumulated data Dq, the control unit 104 sets transmission data for indicating the accumulated social points to the user into the communication data Dm, and transmits the social data to the game system 1 of the user. Thereafter, the control unit 104 deletes the transmitted data related to social points from the accumulated data Dq.

In step S205, the control unit 104 determines whether or not the data received in step S201 is social data indicating that social points are to be given. If the data received in step S201 is such social data, the control unit 104 proceeds to step S206. Otherwise, i.e., if the data received in step S201 is not such social data, the control unit 104 proceeds to step S211 (see FIG. 34).

In step S206, the control unit 104 executes an social data management process, and proceeds to the next step. For example, based on the details of social points indicated by the received social data (the type of the social points, the number of the social points, and a player character PC to which the social points are to be given), the control unit 104 adds the social points, and updates the social data Dp.

Next, the control unit 104 determines whether or not the user to which social points are to be given in step S206 is currently logged in and is playing a game (step S207). If the user to which social points are to be given in step S206 is currently logged in, the control unit 104 proceeds to step S208. Otherwise, i.e., if the user to which social points are to be given in step S206 is not currently logged in, the control unit 104 proceeds to step S209.

In step S208, the control unit 104 executes an social data transmission process, and proceeds to step S211 (see FIG. 34). For example, the control unit 104 sets, into the communication data Dm, transmission data indicating that social points indicated by the received social data are to be given to a party (a player character PC) to which the social points are to be given, and transmits the social data to the game system 1 of the user to which the social points are to be given (the user operating the player character PC to which the social points are to be given).

Meanwhile, in step S209, the control unit 104 executes a data accumulation process, and proceeds to step S211 (see FIG. 34). For example, the control unit 104 temporarily accumulates, in the accumulated data Dq, data indicating that social points indicated by the received social data are to be given to a party to which the social points are to be given.

Referring to FIG. 34, in step S211, the control unit 104 determines whether or not the data received in step S201 indicates a request for map data. If the data received in step S201 indicates a request for map data, the control unit 104 proceeds to step S212. Otherwise, i.e., if the data received in step S201 does not indicates a request for map data, the control unit 104 proceeds to step S213.

In step S212, the control unit 104 executes a process of transmitting information for displaying a map, and proceeds to step S213. For example, the control unit 104 retrieves, from the map data Dr, information for displaying a map that indicates a section activity amount and section reclamation value for each section in a game space in which a user requesting map data is participating, sets transmission data indicating the information for displaying a map into the communication data Dm, and transmits the map data to the game system 1 of the requesting user.

In step S213, the control unit 104 determines whether or not the data received in step S201 is game play data. If the data received in step S201 is game play data, the control unit 104 proceeds to step S214. Otherwise, i.e., if the data received in step S201 is not game play data, the control unit 104 proceeds to step S216.

In step S214, the control unit 104 executes a game play data management process, and proceeds to the next step. For example, the control unit 104 updates a state in each game space or a state of a player character PC based on data related to a player character PC or data related to an object or reclamation region in a game space, which are indicated by the received game play data, and updates the game play data Do.

Next, the control unit 104 executes a process of transmitting the game play data (step S215), and proceeds to step S216. For example, the control unit 104 sets, into the communication data Dm, the game play data received in step S201, as game play data that is to be transmitted to the game system 1 of each user who is participating in a game space in which game play indicated by the game play data is being performed, and transmits the communication data Dm to the game systems 1 of the users.

In step S216, the control unit 104 executes a process of calculating information for displaying a map, and returns to and repeats step S201. For example, based on the game play data and social data received in step S201, the control unit 104 calculates a section activity amount and section reclamation value in a section of the game space of interest, and updates the map data Dr with the result of the calculation.

It should be noted that at least a portion of the processes executed by the game system 1 may be executed in the server 102 or other devices. In addition, at least a portion of the processes executed by the server 102 may be executed by the game system 1 or other devices. As a first example, for the process of accumulating social points given to a player character PC, social points may be accumulated in the server 102 by transmission of information thereof to the server 102 each time the social points are given, and managed for each user. Alternatively, each time data indicating that social points have been given is received by a game system 1, the social points are accumulated in the game system 1, and social points of the user of the game system 1 may be managed in the game system 1. As a second example, for the process of storing and managing the creator of a generated object (a terrain object, a decorative object), the creator of a generated object may be managed in a game system 1 while the object is associated with the creator in the game system 1 each time an object is generated. Alternatively, the creator of a generated object may be managed in the server 102 while the object is associated with the creator in the server 102 each time the server 102 receives data indicating the generation. As a third example, for the process of storing and managing the editor of an edited and/or duplicated object, the editor of an edited and/or duplicated object may be managed in the game system 1 while the object is associated with the last editor in the game system 1 each time the editing and/or duplication are performed. Alternatively, the editor of an edited and/or duplicated object may be managed in the server 102 while the object is associated with the last editor in the server 102 each time the server 102 receives data indicating the editing and/or duplication.

Thus, in the present example, when social points are given to a terrain object or decorative object, the social points are given to not only the creator of the object but also the editor of the object, and therefore, a reward can be given to the editor that gives a motivation for touching the object.

It should be noted that in the present example, data is managed for a player character PC, a process associated with a player character PC's action is performed, and points are given to a player character PC, for example. These examples are also applicable to a user who operates the player character PC. As an example, although in the present example, a player character PC is recorded as the creator or editor of an object, a user operating the player character PC (more specifically, a user ID that is an identifier assigned to the user) may be recorded in association with the object. In that case, even when a user uses a plurality of player characters PC separately in the same game space, social points given to the plurality of player characters PC may be accumulated for the single user. In other words, an object that has been generated, edited, duplicated, or the like by a player character PC can be said to be associated with a user operating the player character PC.

In addition, although in the present example, an object (a terrain object, a decorative object) is generated, edited, or duplicated by a player character PC's action, an object may be generated, edited, or duplicated according to a user's operation without through a player character PC. For example, by a user performing a user instruction operation of directly specifying a location (coordinate point) in the game space, an object associated with the user may be generated, edited, or duplicated at the specified location. In that case, a player character operated by the user does not need to appear in the game space, and social points may be given to the creator and the editor of the object according to the user's operation instruction to perform a predetermined action on an object directly chosen by the user.

In addition, although in the present example, a virtual object generated in a game space by a creator is a content to be evaluated, and social points are given to the creator and the editor of the content to be evaluated, the content to be evaluated is not limited to virtual objects. For example, the content to be evaluated may be a digital content, analog content, mobile content, web content, or the like which is not generated in a virtual space such as a game space. When a predetermined action is performed on these contents as a content to be evaluated, social points may be given to not only the creator but also the editor.

The game system 1 may be any suitable apparatus, including handheld game apparatuses, personal digital assistants (PDAs), mobile telephones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example. In addition, the example operation button used in the above operation is merely illustrative, and the above examples may be implemented using other operation buttons. In addition, there may be a plurality of operation buttons having a similar function (e.g., an operation of giving a high rating (“like”) may be implemented even by pressing down any of the operation buttons 33 to 36 (cross button) or pressing down the operation button 53 (A-button).

The above programs may be supplied to the game system 1 or the server 102 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

Thus, the present example can be used as an information processing system, information processing program, information processing method, and the like in which a privilege or the like can be given to a user who is different from the creator of a first content, and has updated the location of the first content generated by the creator in the same virtual space, or a user that has generated a second content by copying data of the first content generated by the creator in the same virtual space.

What is claimed is:

1. An information processing system comprising:
one or more processors;
a server including a storage unit;
a plurality of information processing apparatuses configured to connect to the server; and
one or more memories storing a program that, when executed, causes the information processing system to perform, based on users' inputs performed on the plurality of information processing apparatuses, operations including:
generating a virtual space including a plurality of sections based on data received from the server;
generating a virtual space image showing the virtual space;
moving a player character operated by the user in the virtual space according to a first input performed by the user;
causing the player character to perform a first action on an object associated with another user in the virtual space according to a second input performed by the user;
storing, into the storage unit, activity amount information based on at least the number of times the first action has been performed during a period of time for each section; and
generating a section information image showing the activity amount information for each of a portion of the plurality of sections based on the activity amount information stored in the storage unit according to a third input performed by the user.

2. The information processing system according to claim 1, wherein
the section includes a plurality of unit regions associated with one of a first and a second state,
further, the player character is caused to perform a second action of choosing at least one of the unit regions based on a fourth input performed by the user, the second action being different from the first action,
the server changes a state of the unit region chosen by the second action to the second state, and storing, into the storage unit, unit region information based on the number of unit regions in the second state for each section, and
the server generates the section information image further showing the unit region information for each section.

3. The information processing system according to claim 1, wherein
the activity amount information shown in the section information image is represented, for each section, by an animation that extends and contracts in a height direction of the section.

4. The information processing system according to claim 2, wherein
further, the section information image is generated by arranging the plurality of sections in a horizontal direction, and
for each section in the section information image, arranged are
a number-of-unit-regions object that is more enlarged in the horizontal direction as the number of the unit regions in the second state indicated by the unit region information increases in the section, and
an activity amount object that is more elongated in a vertical direction as the number of times the first action has been performed that is indicated by the activity amount information increases in the section.

5. The information processing system according to claim 2, wherein
further, the section information image is generated by arranging the plurality of sections in a horizontal direction, and
for each section in the section information image, arranged are
a number-of-unit-regions object that is more enlarged in the horizontal direction as the number of the unit regions in the second state indicated by the unit region information increases in the section, and
an activity amount object whose movement speed increases as the number of times the first action has been performed that is indicated by the activity amount information increases in the section.

6. The information processing system according to claim 2, wherein
further, the section information image is generated by arranging the plurality of sections in a horizontal direction, and
for each section in the section information image, arranged are
a number-of-unit-regions object that is more enlarged in the horizontal direction as the number of the unit regions in the second state indicated by the unit region information increases in the section, and
an activity amount object whose rotational speed increases as the number of times the first action has been performed that is indicated by the activity amount information increases in the section.

7. The information processing system according to claim 1, wherein
the activity amount information further includes information based on distances over which the player character and another player character operated by another user have moved during a period of time for each section.

8. The information processing system according to claim 1, wherein
the activity amount information further includes information based on at least one of a distance and a time over which the player character has moved on an object arranged in the virtual space by another user during a period of time for each section, and information based on at least one of a distance and a time over which another player character operated by the another user has moved on an object arranged in the virtual space by the user during the period of time for each section.

9. The information processing system according to claim 1, wherein
the server stores, into the storage unit, the number of the player characters located in each section, and
the activity amount information further includes information based on the number of the player characters located in each section at a time or during a period of time.

10. The information processing system according to claim 1, wherein
the first action is the player character's action that is performed on an object that has been generated or edited in the virtual space based on the another user's operation to be associated with the another user.

11. The information processing system according to claim 1, wherein
the first action is the player character's action that is performed on an object that exists in the virtual space and has been duplicated based on the another user's operation to be associated with the another user.

12. The information processing system according to claim 1, wherein
the first action is performed on one of a plurality of objects relating to the another user, and
the number of the first actions is counted, considering that the first action has been performed in the section including a location where the player character that has performed the first action is located, or a location where an object on which the first action has been performed is located.

13. An information processing system comprising:
one or more processors;
a server including a storage unit;
a plurality of information processing apparatuses configured to connect to the server; and
one or more memories storing a program that, when executed, causes the information processing system to perform, based on users' inputs performed on the plurality of information processing apparatuses, operations including:
generating a virtual space including a plurality of sections based on data received from the server;
generating a virtual space image showing the virtual space;
moving a player character operated by the user in the virtual space according to a first input performed by the user;
causing the player character to perform a first action on another player character operated by another user in the virtual space according to a second input performed by the user;
storing, into the storage unit, activity amount information based on at least the number of times the first action has been performed during a period of time for each section; and
generating a section information image showing the activity amount information for each of a portion of the plurality of sections based on the activity amount information stored in the storage unit according to a third input performed by the user.

14. A non-transitory computer-readable storage medium having stored therein a program that, when executed, causes one or more processors of one of a plurality of information processing apparatuses configured to connect to a server, to execute information processing comprising:
obtaining virtual space information related to a virtual space including a plurality of sections;
generating the virtual space based on the virtual space information;
moving a player character operated by a user in the virtual space according to a first input performed by the user;
causing the player character to perform a first action on an object associated with another user in the virtual space according to a second input performed by the user;
generating data for transmitting, to the server, data indicating at least that the first action has been performed;
generating a virtual space image showing the virtual space in at least a first scene; and
generating a section information image showing the activity amount information for each of a portion of the plurality of sections based on activity amount information based on at least the number of times the first action has been performed during a period of time for each section in at least a second scene.

15. A non-transitory computer-readable storage medium having stored therein a program that, when executed, causes one or more processors of one of a plurality of information processing apparatuses configured to connect to a server, to execute information processing comprising:
obtaining virtual space information related to a virtual space including a plurality of sections;
generating the virtual space based on the virtual space information;
obtaining location information related to a location in the virtual space of another player character operated by another user;
updating a location of a player character operated by a user and the location in the virtual space of the another player character based on a first input performed by the user and the location information;
causing the player character to perform a first action on the another player character in the virtual space according to a second input performed by the user;
generating data for transmitting, to the server, data indicating at least that the first action has been performed;
generating a virtual space image showing the virtual space in at least a first scene; and
generating a section information image showing the activity amount information for each of a portion of the plurality of sections based on activity amount information based on at least the number of times the first action has been performed during a period of time for each section in at least a second scene.

16. An information processing method for causing one or more processors of an information processing system to at least:
generate a virtual space including a plurality of sections based on data received from a server;
generate a virtual space image showing the virtual space;
move a player character operated by a user in the virtual space according to a first input performed by the user;
cause the player character to perform a first action on an object associated with another user in the virtual space according to a second input performed by the user;
store, into a storage unit, activity amount information based on at least the number of times the first action has been performed during a period of time for each section; and
generate a section information image showing the activity amount information for each of a portion of the plurality of sections based on the activity amount information stored in the storage unit according to a third input performed by the user.

17. An information processing method for causing one or more processors of an information processing system to at least:
generate a virtual space including a plurality of sections based on data received from a server;
generate a virtual space image showing the virtual space;
move a player character operated by a user in the virtual space according to a first input performed by the user;
cause the player character to perform a first action on another player character operated by another user in the virtual space according to a second input performed by the user;
store, into a storage unit, activity amount information based on at least the number of times the first action has been performed during a period of time for each section; and
generate a section information image showing the activity amount information for each of a portion of the plurality of sections based on the activity amount information stored in the storage unit according to a third input performed by the user.
